(19) United States
(12) Patent Application Publication
(10) Pub. No.: US 2013/0213632 A1
(43) Pub. Date: Aug. 22, 2013

(54) THERMAL CONTROL APPARATUS AND METHOD FOR VEHICLE

(71) Applicants: Atsushi Morita, Nagoya-shi (JP); Masaki Morita, Toyota-shi (JP); Miyuki Goto, Kasugai-shi (JP); Satoru Shiga, Nisshin-shi (JP); Shuhei Koyama, Susono-shi (JP)

(72) Inventors: Atsushi Morita, Nagoya-shi (JP); Masaki Morita, Toyota-shi (JP); Miyuki Goto, Kasugai-shi (JP); Satoru Shiga, Nisshin-shi (JP); Shuhei Koyama, Susono-shi (JP)

(73) Assignee: TOYOTA JIDOSHA KABUSHIKI KAISHA, Toyota-shi, Aichi-ken (JP)

(21) Appl. No.: 13/881,035

(22) PCT Filed: Oct. 28, 2011
(86) PCT No.: PCT/IB2011/002549

§ 371 Date: Apr. 23, 2013

(30) Foreign Application Priority Data
Oct. 29, 2010 (JP) 2010-243932

(51) Int. Cl. B60H 1/00; B60H 1/22

(52) U.S. Cl. CPC B60H 1/00478; B60H 1/00278; B60H 1/00328; B60H 1/22; B60H 1/00778; B60H 1/00885
USPC 165/202; 62/3.3; 62/3.61; 165/42

(57) ABSTRACT

A thermal control apparatus for a vehicle includes a first circulation circuit provided with an internal heat exchange unit, a cooling heat thermal storage unit, and a warming heat thermal storage unit, a second circulation circuit provided with an external heat exchange unit, and a Peltier element that transfers heat between a thermal medium in the circuit and a thermal medium in the circuit. When a request to cool a vehicle interior can be met by the cooling heat stored in the thermal storage unit, the vehicle interior is cooled using the cooling heat stored therein with the drive of the Peltier element stopped. When a request to heat the vehicle interior can be met by the warming heat stored in the thermal storage unit, the vehicle interior is heated using the warming heat stored therein with the drive of the Peltier element stopped.

### BACKGROUND OF THE INVENTION

1. Field of the Invention

The invention relates to a thermal control apparatus for a vehicle and a thermal control method therefor.

2. Description of Related Art

In a vehicle such as an automobile or the like, the air-conditioning of a vehicle interior (the control of the temperature of air) is carried out as a kind of thermal control of the vehicle. As such a thermal control apparatus that carries out the air-conditioning of a vehicle interior, as disclosed in, for example, Japanese Patent Application Publication No. 5-338432 (JP-A-5-338432), a control apparatus is available that carries out the air-conditioning such as the cooling and heating of a vehicle interior by a vapor compression-type heat pump (a heat transfer device) that uses carbon dioxide or the like as a thermal medium. Further, the aforementioned thermal control apparatus is also provided with a circulation circuit that circulates a thermal medium such as water or the like to assist the air-conditioning (heating) of the vehicle interior by the aforementioned heat pump. This circulation circuit recovers exhaust heat of the vehicle by the circulating thermal medium, and causes, in an internal heat exchange unit, heat exchange between the aforementioned thermal medium, whose temperature has risen through the recovery of the exhaust heat, and air to be sent into the vehicle interior.

In the aforementioned thermal control apparatus, the air-conditioning of the vehicle interior by the heat pump can be assisted by the circulation circuit, and hence can be carried out swiftly to a corresponding extent. However, the thermal medium such as carbon dioxide or the like needs to be circulated by the vapor compression-type heat pump (the heat transfer device), and the thermal medium such as water or the like needs to be circulated by the circulation circuit. Therefore, the structure of the circuit and the like in the thermal control apparatus inevitably becomes complicated.

### SUMMARY OF THE INVENTION

The invention provides a thermal control apparatus for a vehicle that is not complicated in structure and a thermal control method for a vehicle.

A thermal control apparatus for a vehicle according to a first aspect of the invention includes a first circulation circuit that causes a thermal medium to circulate and flow through an internal heat exchange unit to perform, in the internal heat exchange unit, heat exchange between the thermal medium and air to be sent into a vehicle interior; a second circulation circuit that causes a thermal medium to circulate and flow through an external heat exchange unit to perform, in the external heat exchange unit, heat exchange between the thermal medium and outside air; a heat transfer device that transfers heat between the thermal medium in the first circulation circuit and the thermal medium in the second circulation circuit; and a control section that performs drive control of the heat transfer device, wherein: the heat transfer device is a Peltier element; the first circulation circuit is equipped with a thermal storage unit that stores therein cooling heat or warming heat of the thermal medium, a bypass passage that bypasses the thermal storage unit, and a changeover valve that changes over a circulation path of the thermal medium in the first circulation circuit to one of the thermal storage unit and the bypass passage; and the control section is configured to perform changeover control of the changeover valve and the drive control of the heat transfer device. Since the Peltier element is employed as the heat transfer device for carrying out the air-conditioning of the vehicle interior through the transfer of heat between the thermal medium in the first circulation circuit and the thermal medium in the second circulation circuit, the structure of the circuits and the like in the thermal control apparatus does not become complicated as in a case where, for example, a vapor compression-type heat pump is employed as the heat transfer device.

Further, cooling heat or warming heat can be stored into the thermal storage unit through drive control of the Peltier element (the heat transfer device) and changeover control of the changeover valve by the control section. To be more specific, during the absence of the air-conditioning of the vehicle interior or the like, the Peltier element is driven so that heat transfers from the thermal medium in the second circulation circuit to the thermal medium in the first circulation circuit, and the changeover valve is changed over so that the circulation path of the thermal medium in the first circulation circuit becomes the thermal storage unit, so that warming heat is stored into the thermal storage unit. Meanwhile, during the absence of the air-conditioning of the vehicle interior or the like, when the Peltier element is driven so that heat transfers from the thermal medium in the first circulation circuit to the thermal medium in the second circulation circuit and the changeover valve is changed over so that the circulation path of the thermal medium in the first circulation circuit becomes the thermal storage unit, cooling heat is stored into the thermal storage unit.

In the thermal control apparatus of the foregoing first aspect of the invention, the control section may be configured to perform the drive control of the heat transfer device and the changeover control of the changeover valve based on whether or not an air-conditioning request to carry out air-conditioning of a vehicle interior can be met by the cooling heat or the warming heat stored in the thermal storage unit when the air-conditioning request is made. By using the cooling heat or the warming heat stored in the thermal storage unit to perform the air-conditioning of the vehicle interior and performing the drive control and the changeover control based on whether or not the air-conditioning request can be met by the cooling heat or the warming heat, the number of times the heat transfer device (the Peltier element) is driven and the power supplied thereto in carrying out the aforementioned air-conditioning can be minimized. Accordingly, the amount of the energy consumed in driving the Peltier element in carrying out the air-conditioning of the vehicle interior can be minimized.

In the thermal control apparatus of the foregoing first aspect of the invention, the control section may be configured to change over the changeover valve so that the circulation path of the thermal medium in the first circulation circuit becomes the thermal storage unit and stop driving the Peltier element when it is determined that an air-conditioning request to carry out air-conditioning of the vehicle interior is made and can be met by the cooling heat or the warming heat stored in the thermal storage unit, and be configured to drive the Peltier element so that heat transfers from the thermal medium in the second circulation circuit to the thermal medium in the first circulation circuit when it is determined that the air-conditioning request is made and cannot be met by the cooling heat or the warming heat stored in the thermal storage unit. With this configuration, the air-conditioning (cooling or heating) of the vehicle interior is carried out through drive control of the Peltier element (the heat transfer device) and changeover control of the changeover valve by the control section. To be more specific, when a request for the air-conditioning of the vehicle interior can be met by the cooling heat or warming heat stored in the thermal storage unit, the circulation path of the thermal medium in the first circulation circuit is changed over to the thermal storage unit with the drive of the Peltier element stopped. In this way, the air-conditioning (cooling or heating) of the vehicle interior is carried out using only the cooling heat or warming heat stored in the thermal storage unit. Further, when a request for the air-conditioning of the vehicle interior cannot be met by the cooling heat or warming heat stored in the thermal storage unit, the Peltier element is driven to transfer heat from the thermal medium in the first circulation circuit to the thermal medium in the second circulation circuit or to transfer heat from the thermal medium in the second circulation circuit to the thermal medium in the first circulation circuit. As a result, the air-conditioning (heating or cooling) of the vehicle interior is carried out using the Peltier element, so that the request for the air-conditioning of the vehicle interior can be met. By thus using the cooling heat or warming heat stored in the thermal storage unit for the air-conditioning of the vehicle interior, the number of times the heat transfer device (the Peltier element) is driven and the power supplied thereto in carrying out the aforementioned air-conditioning can be minimized. Accordingly, the amount of the energy consumed in driving the Peltier element in carrying out the air-conditioning of the vehicle interior can be minimized.

It should be noted that when the vehicle interior is heated or cooled through the driving of the Peltier element as described above, the changeover valve may be changed over so that the circulation path of the thermal medium in the first circulation circuit becomes the bypass passage. In this case, the thermal medium circulating in the first circulation circuit does not flow through the thermal storage unit. Therefore, the cooling heat or warming heat stored in the thermal storage unit can be restrained from being discharged from the thermal storage unit by the aforementioned thermal medium flowing through the thermal storage unit.

In the thermal control apparatus of the foregoing first aspect of the invention, the vehicle may include a battery and be configured to be connectable to an external power supply to charge the battery during stoppage of the vehicle, and the control section may be configured to store cooling heat or warming heat into the thermal storage unit through driving of the changeover valve and the Peltier element when the vehicle is connected to the external power supply. With this configuration, when the vehicle is disconnected from the external power supply during the running or the like of the vehicle, the Peltier element is driven using the battery. On the other hand, when the vehicle is connected to the external power supply, the Peltier element can be driven using the external power supply. Thus, when the vehicle is connected to the external power supply, cooling heat or warming heat can be stored into the thermal storage unit through the driving of the changeover valve and the Peltier element by the control section. During this, the Peltier element is driven using the external power supply instead of the battery. Therefore, cooling heat or warming heat can be stored into the thermal storage unit without consuming the power stored in the battery in driving the aforementioned Peltier element.

In the thermal control apparatus of the foregoing first aspect of the invention, a configuration may be employed, in which the vehicle is configured so that one of charge modes, which are a normal charge mode and a quick charge mode, is selected when the vehicle is connected to the external power supply to charge the battery; the first circulation circuit includes, in addition to thermal storage unit and the bypass passage, a path passing through the battery as a circulation path of the thermal medium and is configured to be brought into communication with or shut off from the second circulation circuit through operation of a shutoff valve; the changeover valve is configured to change over the circulation path of the thermal medium in the first circulation circuit to one of the thermal storage unit, the bypass passage, and the path passing through the battery; and the control section is configured to drive the changeover valve and the Peltier element to store cooling heat or warming heat into the thermal storage unit in the normal charge mode, and is configured to change over the changeover valve so that the circulation path of the thermal medium in the first circulation circuit becomes the path passing through the battery, and open the shutoff valve to bring the first circulation circuit into communication with the second circulation circuit with the drive of the Peltier element stopped to restrain a temperature of the battery from rising excessively, or close the shutoff valve to shut off the first circulation circuit from the second circulation circuit and drive the Peltier element so that heat transfers from the thermal medium in the second circulation circuit to the thermal medium in the first circulation circuit to raise the temperature of the battery to a temperature allowing the battery to be charged, in the quick charge mode. With this configuration, when the vehicle is connected to the external power supply to charge the battery and the quick charge mode is selected as the charge mode, the changeover valve is changed over so that the circulation path of the thermal medium in the first circulation circuit becomes the path passing through the battery. Further, in order to restrain the temperature of the battery from rising excessively during the charging of the battery in the quick charge mode, the shutoff valve is opened to bring the first circulation circuit into communication with the second circulation circuit with the drive of the Peltier element stopped. In this case, the thermal medium flowing through the battery flows from the first circulation circuit to the second circulation circuit, is cooled through heat exchange with outside air in the external heat exchange unit of the circuit, then returns to the first circulation circuit, and flows through the aforementioned battery again. As a result, the battery is cooled by the aforementioned thermal medium, and the temperature of the battery is restrained from rising excessively, so that the battery is restrained from deteriorating due to high temperatures. Further, since there is no need to drive the Peltier element in restraining the temperature of the aforementioned battery from rising excessively, the amount of the energy consumed in driving the Peltier element can be made equal to zero. On the other hand, in order to raise the temperature of the battery to a temperature allowing the battery to be charged during the charging of the battery in the quick charge mode, the shutoff valve is closed to shut off the first circulation circuit from the second circulation circuit, and the Peltier element is driven so that heat transfers from the thermal medium in the second circulation circuit to the thermal medium in the first circulation circuit. In this case, the thermal medium flowing through the battery is warmed through the driving of the aforementioned Peltier element, then returns to the aforementioned battery, and flows through the battery again. As a result, the battery is warmed by the aforementioned thermal medium, and the temperature of the battery swiftly rises to the temperature allowing the battery to be charged. The time for charging the battery can thereby be reduced, and hence the battery can be restrained from deteriorating through long hours of charge.

In the thermal control apparatus of the foregoing first aspect of the invention, a configuration may be employed, in which the first circulation circuit is equipped, as the thermal storage unit, with a cooling heat thermal storage unit that stores therein cooling heat of the thermal medium and a warming heat thermal storage unit that stores therein warming heat of the thermal medium; the bypass passage bypasses the cooling heat thermal storage unit and the warming heat thermal storage unit; and the changeover valve is configured to change over the circulation path of the thermal medium in the first circulation circuit to one of the cooling heat thermal storage unit, the warming heat thermal storage unit, and the bypass passage. With this configuration, the vehicle interior can be heated or cooled through drive control of the Peltier element (the heat transfer device) and changeover control of the changeover valve by the control section. To be more specific, when a request to heat the vehicle interior or a request to cool the vehicle interior can be met by the warming heat stored in the warming heat thermal storage unit or the cooling heat stored in the cooling heat thermal storage unit, the circulation path of the thermal medium in the first circulation circuit is changed over to the warming heat thermal storage unit or the cooling heat thermal storage unit with the drive of the Peltier element stopped. Thus, the air-conditioning (heating or cooling) of the vehicle interior is carried out using only the warming heat stored in the warming heat thermal storage unit or the cooling heat stored in the cooling heat thermal storage unit. Further, when a request to heat the vehicle interior or a request to cool the vehicle interior cannot be met by the warming heat stored in the warming heat thermal storage unit or the cooling heat stored in the cooling heat thermal storage unit, the Peltier element is driven to transfer heat from the thermal medium in the second circulation circuit to the thermal medium in the first circulation circuit or to transfer heat from the thermal medium in the first circulation circuit to the thermal medium in the second circulation circuit. As a result, the air-conditioning (heating and cooling) of the vehicle interior is carried out using the Peltier element, so that the request to heat the vehicle interior or the request to cool the vehicle interior can be met. By thus using the warming heat stored in the warming heat thermal storage unit or the cooling heat stored in the cooling heat thermal storage unit for the air-conditioning of the vehicle interior, the number of times the heat transfer device (the Peltier element) is driven and the power supplied thereto in carrying out the aforementioned air-conditioning can be minimized. Accordingly, the amount of the energy consumed in driving the Peltier element in carrying out the air-conditioning of the vehicle interior can be minimized.

It should be noted that the changeover valve may be changed over so that the circulation path of the thermal medium in the first circulation circuit becomes the bypass passage, in heating or cooling the vehicle interior through the driving of the Peltier element as described above. In this case, the thermal medium circulating in the first circulation circuit does not flow through the warming heat thermal storage unit or the cooling heat thermal storage unit. Therefore, the warming heat stored in the warming heat thermal storage unit or the cooling heat stored in the cooling heat thermal storage unit can be restrained from being discharged from the thermal storage unit by the aforementioned thermal medium flowing through the thermal storage unit.

In the thermal control apparatus of the foregoing first aspect of the invention, a configuration may be employed, in which the control section is configured to change over the changeover valve so that the circulation path of the thermal medium in the first circulation circuit becomes the warming heat thermal storage unit and stop driving the Peltier element when it is determined that a heating request to heat the vehicle interior is made and can be met by the warming heat stored in the warming heat thermal storage unit, and is configured to drive the Peltier element so that heat transfers from the thermal medium in the second circulation circuit to the thermal medium in the first circulation circuit when it is determined that the heating request is made and cannot be met by the warming heat stored in the warming heat thermal storage unit. With this configuration, when a request to heat the vehicle interior is made and can be met by the warming heat stored in the warming heat thermal storage unit, the changeover valve is changed over so that the circulation path of the thermal medium in the first circulation circuit becomes the warming heat thermal storage unit with the drive of the Peltier element stopped. In this case, the request to heat the vehicle interior is met by the warming heat stored in the warming heat thermal storage unit. Further, since the drive of the Peltier element is stopped in carrying out the air-conditioning to meet the request to heat the vehicle interior, the amount of the energy consumed in driving the Peltier element can be minimized. On the other hand. When a request to heat the vehicle interior is made and cannot be met by the warming heat stored in the warming heat thermal storage unit because the amount thereof is small, the Peltier element is driven so that heat transfers from the thermal medium in the second circulation circuit to the thermal medium in the first circulation circuit. Due to this driving of the Peltier element, the request to heat the vehicle interior can be met even when the amount of the warming heat stored in the warming heat thermal storage unit is small.

In the thermal control apparatus of the foregoing first aspect of the invention, the control section may be configured to change over the changeover valve so that the circulation path of the thermal medium in the first circulation circuit becomes the cooling heat thermal storage unit and stop driving the Peltier element when it is determined that a cooling request to cool the vehicle interior is made and can be met by the cooling heat stored in the cooling heat thermal storage unit, and be configured to drive the Peltier element so that heat transfers from the thermal medium in the first circulation circuit to the thermal medium in the second circulation circuit when it is determined that the cooling request is made and cannot be met by the cooling heat stored in the cooling heat thermal storage unit. With this configuration, when a request to cool the vehicle interior is made and can be met by the cooling heat stored in the cooling heat thermal storage unit, the changeover valve is changed over so that the circulation path of the thermal medium in the first circulation circuit becomes the cooling heat thermal storage unit, with the drive of the Peltier element stopped. In this case, the request to cool the vehicle interior is met by the cooling heat stored in the cooling heat thermal Storage unit. Further, since the drive of the Peltier element is stopped in carrying out the air-conditioning to meet the request to cool the vehicle interior, the amount of the energy consumed in driving the Peltier element can be minimized. On the other hand, when a request to cool the vehicle interior is made and cannot be met by the cooling heat stored in the cooling heat thermal storage unit because the amount thereof is small, the Peltier element is driven so that heat transfers from the thermal medium in the first circulation circuit to the thermal medium in the second circulation circuit. Due to this driving of the Peltier element, the request to cool the vehicle interior can be met even when the amount of the cooling heat stored in the cooling heat thermal storage unit is small.

In the thermal control apparatus of the foregoing first aspect of the invention, the vehicle may include a battery and be configured to be connectable to an external power supply to charge the battery during stoppage of the vehicle, and the control section may be configured to store warming heat into the warming heat thermal storage unit or store cooling heat into the cooling heat thermal storage unit through driving of the changeover valve and the Peltier element when the vehicle is connected to the external power supply. With this configuration, when the vehicle is disconnected from the external power supply during the running or the like of the vehicle, the Peltier element is driven using the battery. On the other hand, when the vehicle is connected to the external power supply, the Peltier element can be driven using the external power supply. When the vehicle is connected to the external power supply, warming heat is stored into the warming heat thermal storage unit or cooling heat is stored into the cooling heat thermal storage unit through the driving of the changeover valve and the Peltier element by the control section. During this, the Peltier element is driven using the external power supply instead of the battery. Therefore, warming heat can be stored into the warming heat thermal storage unit or cooling heat can be stored into the cooling heat thermal storage unit without consuming the power stored in the battery in driving the aforementioned Peltier element.

In the thermal control apparatus of the foregoing first aspect of the invention, a configuration may be employed, in which the vehicle is configured so that one of charge modes, which are a normal charge mode and a quick charge mode, is selected when the vehicle is connected to the external power supply to charge the battery; the first circulation circuit includes, in addition to the cooling heat thermal storage unit, the warming heat thermal storage unit, and the bypass passage, a path passing through the battery, as a circulation path of the thermal medium and is configured to be brought into communication with or shut off from the second circulation circuit through operation of a shutoff valve; the changeover valve is configured to change over the circulation path of the thermal medium in the first circulation circuit to one of the cooling heat thermal storage unit, the warming heat thermal storage unit, the bypass passage, and the path passing through the battery; and the control section is configured to drive the changeover valve and the Peltier element to store warming heat into the warming heat thermal storage unit or store cooling heat into the cooling heat thermal storage unit in the normal charge mode, and is configured to change over the changeover valve so that the circulation path of the thermal medium in the first circulation circuit becomes the path passing through the battery, and open the shutoff valve to bring the first circulation circuit into communication with the second circulation circuit with the drive of the Peltier element stopped to restrain a temperature of the battery from rising excessively, or close the shutoff valve to shut off the first circulation circuit from the second circulation circuit and drive the Peltier element so that heat transfers from the thermal medium in the second circulation circuit to the thermal medium in the first circulation circuit to raise the temperature of the battery to a temperature allowing the battery to be charged, in the quick charge mode. With this configuration, when the vehicle is connected to the external power supply to charge the battery and the quick charge mode is selected as the charge mode, the changeover valve is changed over so that the circulation path of the thermal medium in the first circulation circuit becomes the path passing through the battery. Further, in order to restrain the temperature of the battery from rising excessively during the charging of the battery in the quick charge mode, the shutoff valve is opened to bring the first circulation circuit into communication with the second circulation circuit, with the drive of the Peltier element stopped. In this case, the thermal medium flowing through the battery flows from the first circulation circuit to the second circulation circuit, is cooled through heat exchange with outside air in the external heat exchange unit of the circuit, then returns to the first circulation circuit, and flows through the aforementioned battery again. As a result, the battery is cooled by the aforementioned thermal medium, and the temperature of the battery is restrained from rising excessively, so that the battery is restrained from deteriorating due to high temperatures. Further, since there is no need to drive the Peltier element in restraining the temperature of the aforementioned battery from rising excessively, the amount of the energy consumed in driving the Peltier element can be made equal to zero. On the other hand, in order to raise the temperature of the battery to a temperature allowing the battery to be charged during the charging of the battery in the quick charge mode, the shutoff valve is closed to shut off the first circulation circuit from the second circulation circuit, and the Peltier element is driven so that heat transfers from the thermal medium in the second circulation circuit to the thermal medium in the first circulation circuit. In this case, the thermal medium flowing through the battery is warmed through the driving of the aforementioned Peltier element, then returns to the aforementioned battery, and flows through the battery again. As a result, the battery is warmed by the aforementioned thermal medium, and the temperature of the battery swiftly rises to the temperature allowing the battery to be charged. The time for charging the battery can thereby be reduced, and hence the battery can be restrained from deteriorating through long hours of charge.

A thermal control method for a vehicle according to a second aspect of the invention includes: performing heat exchange in a first circulation circuit that causes a thermal medium to flow through an internal heat exchange unit to perform the heat exchange between the thermal medium and air to be sent into a vehicle interior, wherein the first circulation circuit is equipped with a thermal storage unit that stores therein cooling heat or warming heat of the thermal medium, a bypass passage that bypasses the thermal storage unit, and a changeover valve that changes over a circulation path of the thermal medium to one of the thermal storage unit and the bypass passage; performing heat exchange in a second circulation circuit that causes a thermal medium to flow through an external heat exchange unit to perform the heat exchange between the thermal medium and outside air; transferring heat between the thermal medium in the first circulation circuit and the thermal medium in the second circulation circuit via a Peltier element; and performing drive control of the Peltier element and changeover control of the changeover valve based on whether or not an air-conditioning request to carry out air-conditioning of the vehicle interior can be met by the cooling heat or the warming heat stored in the thermal storage unit.

In the thermal control method of the foregoing second aspect of the invention, a configuration may be employed, in which the drive control and the changeover control includes: changing over the changeover valve so that the circulation path of the thermal medium in the first circulation circuit becomes the thermal storage unit and stopping driving the Peltier element when it is determined that the air-conditioning request can be met by the cooling heat or the warming heat stored in the thermal storage unit; and driving the Peltier element so that heat transfers from the thermal medium in the second circulation circuit to the thermal medium in the first circulation circuit when it is determined that the air-conditioning request cannot be met by the cooling heat or the warming heat stored in the thermal storage unit.

In the thermal control method of the foregoing second aspect of the invention, the vehicle may include a battery and be configured to be connectable to an external power supply to charge the battery during stoppage of the vehicle, and the thermal control method may further include storing cooling heat or warming heat into the thermal storage unit through driving of the changeover valve and the Peltier element when the vehicle is connected to the external power supply.

In the thermal control method of the foregoing second aspect of the invention, a configuration may be employed, in which the first circulation circuit includes, in addition to the thermal storage unit and the bypass passage, a path passing through the battery as a circulation path of the thermal medium and is configured to be brought into communication with or shut off from the second circulation circuit through operation of a shutoff valve; the changeover valve is configured to change over the circulation path of the thermal medium in the first circulation circuit to one of the thermal storage unit, the bypass passage, and the path passing through the battery; and the thermal control method further comprises: selecting one of charge modes, which are a normal charge mode and a quick charge mode, when the vehicle is connected to the external power supply to charge the battery; performing the changeover control of the changeover valve and the drive control of the Peltier element to store cooling heat or warming heat into the thermal storage unit in the normal charge mode; and changing over the changeover valve so that the circulation path of the thermal medium in the first circulation circuit becomes the path passing through the battery, and, to restrain a temperature of the battery from rising excessively, opening the shutoff valve to bring the first circulation circuit into communication with the second circulation circuit with the drive of the Peltier element stopped, or, to raise the temperature of the battery to a temperature allowing the battery to be charged, closing the shutoff valve to shut off the first circulation circuit from the second circulation circuit and driving the Peltier element so that heat transfers from the thermal medium in the second circulation circuit to the thermal medium in the first circulation circuit, in the quick charge mode.

In the thermal control method of the foregoing second aspect of the invention, a configuration may be employed, in which the first circulation circuit is equipped, as the thermal storage unit, with a cooling heat thermal storage unit that stores therein cooling heat of the thermal medium and a warming heat thermal storage unit that stores therein warming heat of the thermal medium; the bypass passage bypasses the cooling heat thermal storage unit and the warming heat thermal storage unit; the changeover valve is configured to change over the circulation path of the thermal medium in the first circulation circuit to one of the cooling heat thermal storage unit, the warming heat thermal storage unit, and the bypass passage; and the thermal control method further comprises: changing over the changeover valve so that the circulation path of the thermal medium in the first circulation circuit becomes the warming heat thermal storage unit and stopping driving the Peltier element when it is determined that a heating request to heat the vehicle interior can be met by the warming heat stored in the warming heat thermal storage unit; and driving the Peltier element so that heat transfers from the thermal medium in the second circulation circuit to the thermal medium in the first circulation circuit when it is determined that the heating request cannot be met by the warming heat stored in the warming heat thermal storage unit.

In the thermal control method of the foregoing second aspect of the invention, a configuration may be employed, in which the first circulation circuit is equipped, as the thermal storage unit, with a cooling heat thermal storage unit that stores therein cooling heat of the thermal medium and a warming heat thermal storage unit that stores therein warming heat of the thermal medium; the bypass passage bypasses the cooling heat thermal storage unit and the warming heat thermal storage unit; the changeover valve is configured to change over the circulation path of the thermal medium in the first circulation circuit to one of the cooling heat thermal storage unit, the warming heat thermal storage unit, and the bypass passage; and the thermal control method further comprises: changing over the changeover valve so that the circulation path of the thermal medium in the first circulation circuit becomes the cooling heat thermal storage unit and stopping driving the Peltier element when it is determined that a cooling request to cool the vehicle interior can be met by the cooling heat stored in the cooling heat thermal storage unit; and driving the Peltier element so that heat transfers from the thermal medium in the first circulation circuit to the thermal medium in the second circulation circuit when it is determined that the cooling request cannot be met by the cooling heat stored in the cooling heat thermal storage unit.

In the thermal control method of the foregoing second aspect of the invention, a configuration may be employed, in which the first circulation circuit is equipped, as the thermal storage unit, with a cooling heat thermal storage unit that stores therein cooling heat of the thermal medium and a warming heat thermal storage unit that stores therein warming heat of the thermal medium; the bypass passage bypasses the cooling heat thermal storage unit and the warming heat thermal storage unit; the changeover valve is configured to change over the circulation path of the thermal medium in the first circulation circuit to one of the cooling heat thermal storage unit, the warming heat thermal storage unit, and the bypass passage; the vehicle includes a battery and is configured to be connectable to an external power supply to charge the battery during stoppage of the vehicle; and the thermal control method further comprises: storing warming heat into the warming heat thermal storage unit or storing cooling heat into the cooling heat thermal storage unit through driving of the changeover valve and the Peltier element when the vehicle is connected to the external power supply.

In the thermal control method of the foregoing second aspect of the invention, a configuration may be employed, in which the first circulation circuit includes, in addition to the cooling heat thermal storage unit, the warming heat thermal storage unit, and the bypass passage, a path passing through the battery, as a circulation path of the thermal medium and is configured to be brought into communication with or shut off from the second circulation circuit through operation of a shutoff valve; the changeover valve is configured to change over the circulation path of the thermal medium in the first circulation circuit to one of the cooling heat thermal storage unit, the warming heat thermal storage unit, the bypass passage, and the path passing through the battery; and the thermal control method further comprises: selecting one of charge modes, which are a normal charge mode and a quick charge mode, when the vehicle is connected to the external power supply to charge the battery; performing the changeover control of the changeover valve and the drive control of the Peltier element to store warming heat into the warming heat thermal storage unit or store cooling heat into the cooling heat thermal storage unit in the normal charge mode; and changing over the changeover valve so that the circulation path of the thermal medium in the first circulation circuit becomes the path passing through the battery, and, to restrain a temperature of the battery from rising excessively, opening the shutoff valve to bring the first circulation circuit into communication with the second circulation circuit with the drive of the Peltier element stopped, or, to raise the temperature of the battery to a temperature allowing the battery to be charged, closing the shutoff valve to shut off the first circulation circuit from the second circulation circuit and driving the Peltier element so that heat transfers from the thermal medium in the second circulation circuit to the thermal medium in the first circulation circuit, in the quick charge mode.

### BRIEF DESCRIPTION OF THE DRAWINGS

Features, advantages, and technical and industrial significance of an exemplary embodiment of the invention will be described below with reference to the accompanying drawings, in which like numerals denote like elements, and wherein:

FIG. 1 is a schematic diagram showing an overall configuration of a thermal control apparatus in this embodiment of the invention;

FIG. 2 is a schematic diagram showing a circulation mode of a thermal medium in first to third circulation circuits of the thermal control apparatus;

FIG. 3 is a schematic diagram showing a circulation mode of the thermal medium in the first to third circulation circuits of the thermal control apparatus;

FIG. 4 is a schematic diagram showing a circulation mode of the thermal medium in the first to third circulation circuits of the thermal control apparatus;

FIG. 5 is a schematic diagram showing a circulation mode of the thermal medium in the first to third circulation circuits of the thermal control apparatus;

FIG. 6 is a schematic diagram showing a circulation mode of the thermal medium in the first to third circulation circuits of the thermal control apparatus;

FIG. 7 is a schematic diagram showing a circulation mode of the thermal medium in the first to third circulation circuits of the thermal control apparatus;

FIG. 8 is a schematic diagram showing a circulation mode of the thermal medium in the first to third circulation circuits of the thermal control apparatus;

FIG. 9 is a schematic diagram showing a circulation mode of the thermal medium in the first to third circulation circuits of the thermal control apparatus;

FIG. 10 is a flowchart showing a procedure of performing a processing for charging a battery of a vehicle and storing heat into a thermal storage unit when the vehicle is stopped;

FIG. 11 is a flowchart showing a procedure of performing a processing of carrying out the air-conditioning of a vehicle interior when the vehicle is driven;

FIG. 12 is an explanatory diagram showing, in the form of a table, a mode of carrying out thermal storage unit air-conditioning and a mode of carrying out Peltier air-conditioning;

FIG. 13 is a schematic diagram showing another example of circulation circuits of a thermal control apparatus; and

FIG. 14 is a schematic diagram showing a circulation mode of a thermal medium in the circulation circuit.

### DETAILED DESCRIPTION OF EMBODIMENT

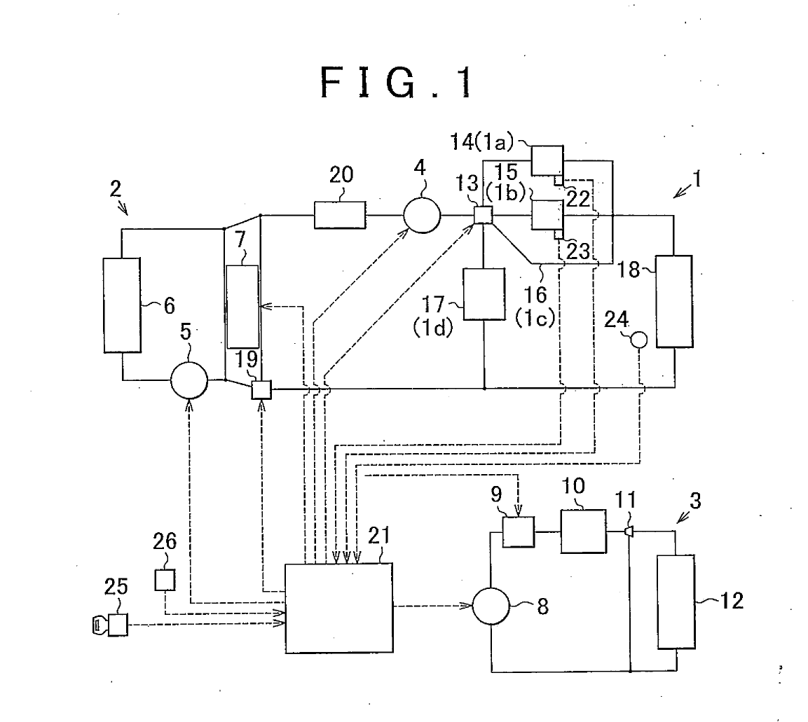

One embodiment obtained by embodying the invention as a thermal control apparatus for a vehicle will be described hereinafter with reference to FIGS. 1 to 12. The vehicle of this embodiment of the invention can be caused to run by a motor that is driven by power of a battery, and is connectable to an external power supply to charge the aforementioned battery during a stoppage of the vehicle. This vehicle is provided with a thermal control apparatus that carries out air-conditioning or the like of a vehicle interior as one kind of thermal control. As shown in FIG. 1, this thermal control apparatus includes a first circulation circuit 1 in which a thermal medium such as water or the like circulates, driven by a pump 4, a second circulation circuit 2 in which a thermal medium such as water circulates, driven by a pump 5, and a third circulation circuit 3 in which a thermal medium such as water circulates, driven by a pump 8.

In the aforementioned first circulation circuit 1, the air-conditioning of the vehicle interior can be carried out using the thermal medium circulating, driven by the pump 4. Further, in the aforementioned second circulation circuit 2, when the thermal medium circulating, driven by the pump 5 flows through an external heat exchange unit 6, heat exchange can be carried out between the thermal medium and outside air. Provided between this first circulation circuit 1 and this second circulation circuit 2 is a Peltier element 7 that operates upon being supplied with power from the aforementioned battery or the aforementioned external power supply, as a heat transfer device that transfers heat between the thermal medium in the first circulation circuit 1 and the thermal medium in the second circulation circuit 2.

On the other hand, in the aforementioned third circulation circuit 3, the thermal medium circulating, driven by the pump 8 flows through a charger 9 and a transaxle 10. The aforementioned charger 9 is designed to raise the voltage of the external power supply connected to the vehicle to a value allowing the battery to be charged, and is operated, for example, when a domestic power supply is connected to the vehicle as the aforementioned external power supply. Then, during the operation of the charger 9, exhaust heat from the charger 9 is recovered by the thermal medium circulating in the third circulation circuit. The exhaust heat thus recovered by the thermal medium is delivered to the transaxle 10 when the thermal medium flows through the transaxle 10.

Further, the third circulation circuit 3 branches off, at a thermostat 11, into a path circulating through a heat radiation unit 12, and a path bypassing the heat radiation unit 12. The aforementioned thermostat 11 prohibits/allows the flow of the thermal medium through the aforementioned heat radiation unit 12 in accordance with the temperature of the thermal medium in the third circulation circuit 3. That is, when the temperature of the thermal medium in the third circulation circuit 3 is high, the thermal medium is allowed to flow through the aforementioned heat radiation unit 12 through the operation of the aforementioned thermostat 11, so that the aforementioned thermal medium flows through the heat radiation unit 12 to radiate heat in the heat radiation unit 12. As a result, the temperature of the thermal medium is restrained from rising excessively in the third circulation circuit 3. On the other hand, when the temperature of the thermal medium in the third circulation circuit 3 is high, the thermal medium is prohibited from flowing through the aforementioned heat radiation unit 12 through the operation of the aforementioned thermostat 11, so that the aforementioned thermal medium is caused to circulate bypassing the heat radiation unit 12. As a result, the thermal medium does not radiate heat in the heat radiation unit 12, and the temperature of the thermal medium in the third circulation circuit 3 is prevented from becoming excessively low.

Next, the aforementioned first circulation circuit 1 will be described in detail. The first circulation circuit 1 branches off, at a changeover valve 13 provided downstream of the pump 4, into four paths, namely, a path 1a passing through a cooling heat thermal storage unit 14, a path 1b passing through a warming heat thermal storage unit 15, a path 1c passing through a bypass passage 16, and a path 1d passing through a battery 17. The aforementioned changeover valve 13 operates in such a manner as to change over the circulation path of the thermal medium in the first circulation circuit 1 to one of the cooling heat thermal storage unit 14 (the path 1a), the warming heat thermal storage unit 15 (the path 1b), the bypass passage 16 (the path 1c), and the battery 17 (the path 1d). It should be noted that the paths 1a to 1c in the first circulation circuit 1 join into a single path upstream of an internal heat exchange unit 18. This internal heat exchange unit 18 is designed to perform heat exchange between the thermal medium flowing through the internal heat exchange unit 18 and air to be sent into the vehicle interior. A region of the first circulation circuit 1 located downstream of the internal heat exchange unit 18 joins a downstream region of the path 1d and then leads to a shutoff valve 19. The shutoff valve 19 operates to bring the first circulation circuit 1 into communication with the second circulation circuit 2 or shut off the first circulation circuit 1 from the second circulation circuit 2.

An inverter 20 for driving a motor of the vehicle is provided, as an exhaust heat recovery object, downstream of the shutoff valve 19 and upstream of the pump 5 in the first circulation circuit 1. Accordingly, during the operation of the inverter 20 for driving the motor, exhaust heat from the inverter 20 is recovered by the thermal medium circulating in the first circulation circuit 1. Further, the aforementioned Peltier element 7 is located in that region of the first circulation circuit 1 which is located downstream of the shutoff valve 19 and upstream of the inverter 20. This Peltier element 7 is located in that region of the second circulation circuit 2 which is located downstream of the external heat exchange unit 6 and upstream of the pump 5. Then, through the driving of the Peltier element 7, the heat of the thermal medium in the second circulation circuit 2 is transferred to the thermal medium in the first circulation circuit 1, or the heat of the thermal medium in the first circulation circuit 1 is transferred to the thermal medium in the second circulation circuit 2.

Next, the electric configuration of the thermal control apparatus for the vehicle will be described. This thermal control apparatus includes an electronic control unit 21 that performs various kinds of control such as drive control of the motor in the vehicle, air-conditioning control of the vehicle interior, and the like. This electronic control unit 21 includes a central processing unit (CPU) that performs various calculation processings concerning the aforementioned control, a read only memory (ROM) in which programs and data needed for the control are stored, a RAM in which a calculation result of the CPU and the like are temporarily stored, input/output ports for inputting/outputting signals from/to the outside, and the like.

Various sensors and the like, such as a first temperature sensor 22 that detects a temperature in the cooling heat thermal storage unit 14, a second temperature sensor 23 that detects a temperature in the warming heat thermal storage unit 15, and a third temperature sensor 24 that detects a temperature (a blowoff temperature) of the air blown out into the vehicle interior after flowing through the internal heat exchange unit 18 are connected to input ports of the electronic control unit 21. Furthermore, a ready switch 25 that is operated upon the start or stop of the driving of the vehicle to output a signal corresponding to an operation position, and a plug-in detection circuit 26 that outputs a signal corresponding to the connection/disconnection of the vehicle to/from an external power supply are also connected to the aforementioned input ports. On the other hand, drive circuits and the like for various components such as the pump 4, the pump 5, the Peltier element 7, the pump 8, the charger 9, the changeover valve 13, and the shutoff valve 19 are connected to output ports of the electronic control unit 21.

The electronic control unit 21 outputs command signals to the drive circuits for the components such as the pump 4, the Peltier element 7, and the changeover valve 13 according to detection signals input from the aforementioned various sensors, a request to cool or heat the vehicle interior, and the like, in order to carry out the air-conditioning of the vehicle interior during the driving of the vehicle or the like. Thus, drive control of the pump 4, drive control of the Peltier element 7, drive control of the changeover valve 13 and the like for carrying out the air-conditioning of the vehicle interior are performed through the electronic control unit 21.

It should be noted that the magnitude of a request to cool the vehicle interior or the magnitude of a request to heat the vehicle interior can be calculated based on a blowoff temperature calculated from a detection signal of the third temperature sensor 24 and a target blowoff temperature as a target value of the blowoff temperature. The aforementioned target blowoff temperature is a value calculated based on a set temperature in the vehicle interior, which is determined by a passenger of the vehicle, an actual temperature in the vehicle interior, and an amount of sunlight pouring into the vehicle interior, and the like. It can then be determined that the lower the aforementioned target blowoff temperature is below the blowoff temperature calculated from the detection signal of the third temperature sensor 24, the greater the magnitude of a request to cool the vehicle interior is. On the other hand, it can be determined that the higher the aforementioned target blowoff temperature is above the blowoff temperature calculated from the detection signal of the third temperature sensor 24, the greater the magnitude of a request to heat the vehicle interior is.

Further, the electronic control unit 21 grasps a remaining thermal storage amount of the cooling heat thermal storage unit 14 and a remaining thermal storage amount of the warming heat thermal storage unit 15 based on detection signals input from the aforementioned various sensors, for example, while an external power supply is connected to the stopped vehicle. The electronic control unit 21 then outputs command signals to the drive, circuits of the components such as the pump 4, the Peltier element 7, and the changeover valve 13 to store cooling heat into the cooling heat thermal storage unit 14 or store warming heat into the warming heat thermal storage unit 15 according to the remaining thermal storage amount thus grasped. In this manner, drive control of the pump 4, drive control of the Peltier element 7, drive control of the changeover valve 13, and the like for storing cooling heat into the cooling heat thermal storage unit 14 or storing warming heat into the warming heat thermal storage unit 15 are performed through the electronic control unit 21.

Furthermore, while the external power supply (i.e., a domestic power supply or a public power supply) is connected to the stopped vehicle, the electronic control unit 21 grasps a remaining amount of the battery 17 upon the connection of the external power supply, and charges the battery 17 according to the grasped remaining amount of the battery 17 or the like. When the battery 17 is charged in this way, one of charge modes, which are a normal charge mode and a quick charge mode, is selected, and the aforementioned battery 17 is charged in accordance with the selected charge mode. The aforementioned normal charge mode is selected when the vehicle is connected to, for example, the domestic power supply as the external power supply. Further, the aforementioned quick charge mode is selected when the vehicle is connected to, for example, the public power supply as the external power supply.

It should be noted that in the aforementioned normal charge mode, the electronic control unit 21 outputs a command signal to the drive circuit of the charger 9 to raise the voltage of the domestic power supply to a value allowing the battery 17 to be charged, and charges the battery 17 using the domestic power supply through drive control of the charger 9 based on the command signal. On the other hand, in the aforementioned quick charge mode, the battery 17 is charged using the public power supply, which is provided for the purpose of charging the battery 17. Since the voltage of this public power supply is set in advance to a value allowing the battery 17 to be charged, there is no need to operate the charger 9 to raise the aforementioned voltage. Thus, in the aforementioned quick charge mode, the electronic control unit 21 charges the battery 17 using the public power supply, without operating the charger 9.

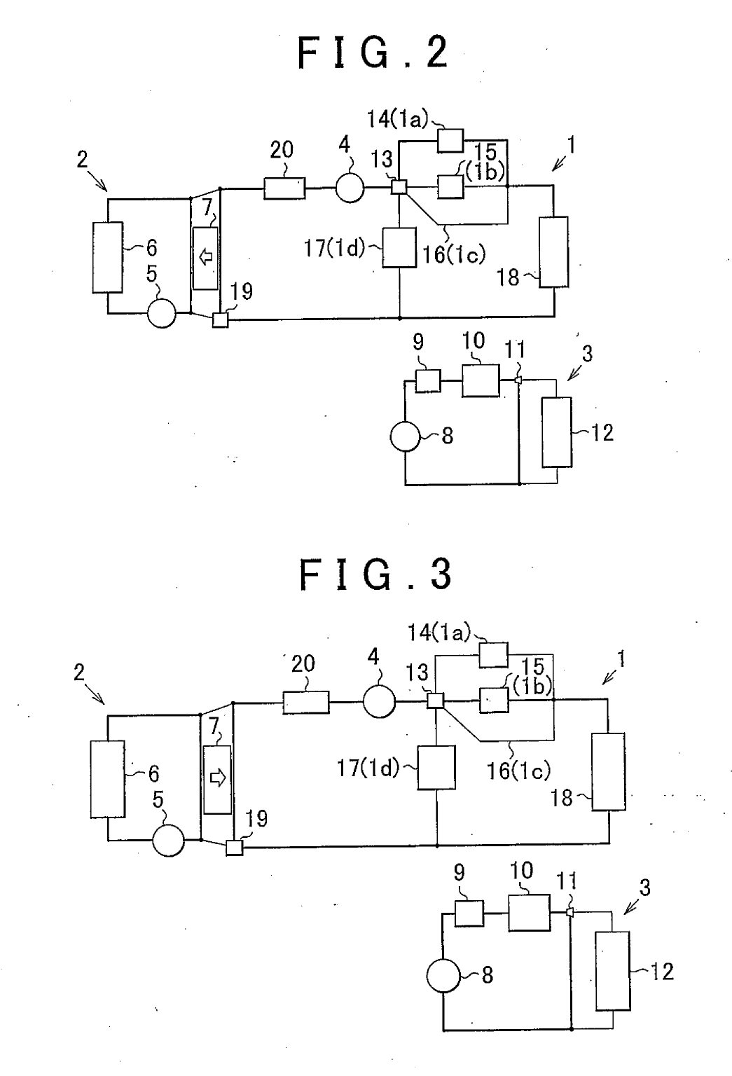

Next, circulation modes of a thermal medium in the first circulation circuit 1, the second circulation circuit 2, and the third circulation circuit 3 will be described in detail individually for various situations of the vehicle with reference to FIGS. 2 to 9. FIG. 2 shows a circulation mode of the thermal medium in the first circulation circuit 1, the second circulation circuit 2, and the third circulation circuit 3 at the time when the stopped vehicle is connected to a domestic power supply in summer. When the vehicle is thus connected to the domestic power supply, the normal charge mode is selected as the charge mode for charging the battery 17. In the normal charge mode, the voltage of the domestic power supply is raised, through the operation of the charger 9, to a value allowing the battery 17 to be charged, so that the battery 17 can be charged using the domestic power supply. During the charging of the battery 17 in this normal charge mode, the thermal medium in the third circulation circuit 3 is circulated, driven by the pump 8, so that exhaust heat during the operation of the charger 9 is recovered by the aforementioned circulating thermal medium and then delivered to the transaxle 10 by the thermal medium.

In the normal charge mode in summer, while the battery 17 is charged as described above, cooling heat is also stored into the cooling heat thermal storage unit 14 through drive control of the Peltier element 7 and changeover control of the changeover valve 13. More specifically, first of all, with the thermal medium in the first circulation circuit 1 circulated, driven by the pump 4 and the thermal medium in the second circulation circuit 2 circulated, driven by the pump 5, the first circulation circuit 1 and the second circulation circuit 2 are shut off from each other through the operation of closing the shutoff valve 19. In this state, the Peltier element 7 is driven using the domestic power supply so that heat transfers from the thermal medium in the first circulation circuit 1 to the thermal medium in the second circulation circuit 2. It should be noted that an outline arrow in the Peltier element 7 in the drawing indicates the transfer of heat resulting from the driving of the Peltier element 7. Thus, the temperature of the thermal medium circulating in the first circulation circuit 1 falls. Furthermore, by changing over the changeover valve 13 so that the circulation path of the thermal medium in the first circulation circuit 1 becomes the cooling heat thermal storage unit 14 (the path 1a), the low-temperature thermal medium is caused to flow through the cooling heat thermal storage unit 14, and cooling heat is stored into the cooling heat thermal storage unit 14. It should be noted that when the changeover valve 13 is changed over, upon the completion of the storage of cooling heat into the cooling heat thermal storage unit 14, so that the circulation path of the thermal medium in the first circulation circuit 1 becomes a path other than the cooling heat thermal storage unit 14 (the path 1a), the cooling heat stored in the cooling heat thermal storage unit 14 can be retained.

FIG. 3 shows a circulation mode of the thermal medium in the first circulation circuit 1, the second circulation circuit 2, and the third circulation circuit 3 at the time when the stopped vehicle is connected to the domestic power supply in winter. When the vehicle is thus connected to the domestic power supply as well, the normal charge mode is selected as the charge mode for charging the battery 17. As a result, the battery 17 is charged in the same manner as in the aforementioned normal charge mode in summer. Furthermore, the thermal medium is circulated in the third circulation circuit 3 as well, so that the exhaust heat of the charger 9 is recovered and also delivered to the transaxle 10.

In the normal charge mode in winter, while the aforementioned battery 17 is charged, warming heat is also stored into the warming heat thermal storage unit 15 through drive control of the Peltier element 7 and changeover control of the changeover valve 13. More specifically, in the same manner as in summer, with the thermal medium in the first circulation circuit 1 circulated, driven by the pump 4 and the thermal medium in the second circulation circuit 2 circulated, driven by the pump 5, the first circulation circuit 1 and the second circulation circuit 2 are shut off from each other through the operation of closing the shutoff valve 19. In this state, inversely to the case of summer, the Peltier element 7 is driven using the domestic power supply so that heat transfers from the thermal medium in the first circulation circuit 1 to the thermal medium in the second circulation circuit 2. It should be noted that an outline arrow in the Peltier element 7 in the drawing indicates the transfer of heat resulting from the driving of the Peltier element 7. Thus, the temperature of the thermal medium circulating in the first circulation circuit 1 rises. Furthermore, by changing over the changeover valve 13 so that the circulation path of the thermal medium in the first circulation circuit 1 becomes the warming heat thermal storage unit 15 (the path 1b), the high-temperature thermal medium is caused to flow through the warming heat thermal storage unit 15, and warming heat is stored into the warming heat thermal storage unit 15. It should be noted that when the changeover valve 13 is changed over, upon the completion of the storage of warming heat into the warming heat thermal storage unit 15 so that the circulation path of the thermal medium in the first circulation circuit 1 becomes a path other than the warming heat thermal storage unit 15 (the path 1b), the warming heat stored in the warming heat thermal storage unit 15 can be retained.

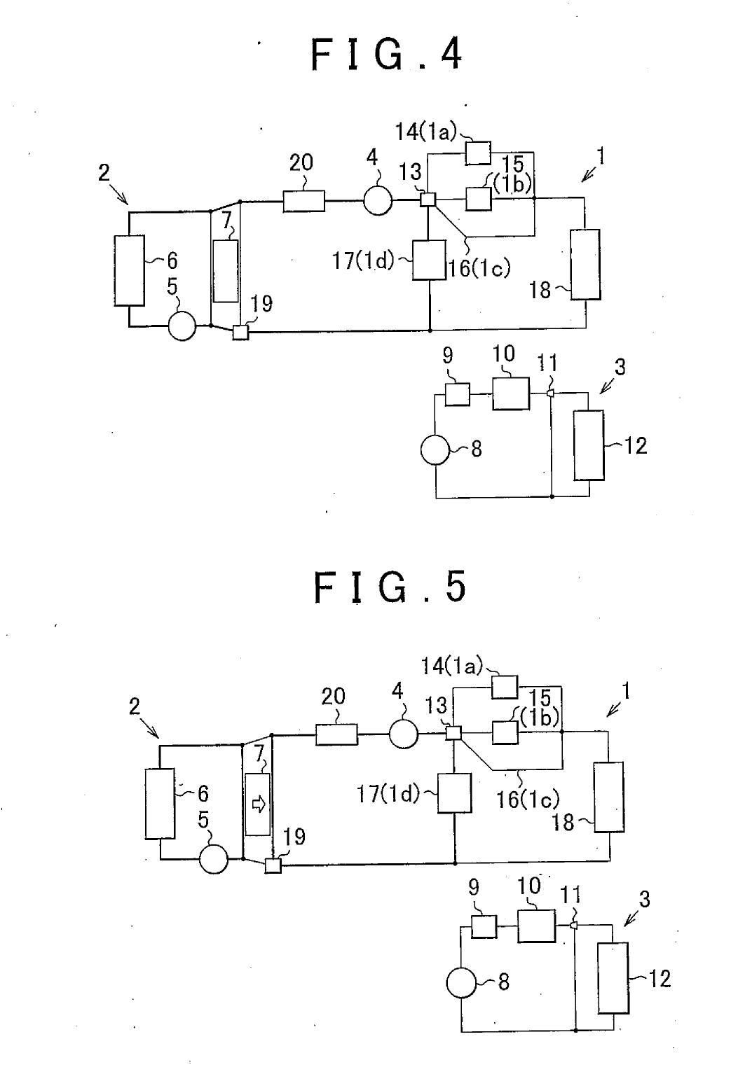

FIG. 4 shows a circulation mode of the thermal medium in the first circulation circuit 1, the second circulation circuit 2, and the third circulation circuit 3 at the time when the stopped vehicle is connected to the public power supply in summer. When the vehicle is thus connected to the public power supply, the quick charge mode is selected as the charge mode for charging the battery 17. In the quick charge mode, since the battery 17 is charged using the public power supply without operating the charger 9, no exhaust heat is generated from the charger 9 as a result of the operation of the charger 9. Thus, there is no need to circulate the thermal medium in the third circulation circuit 3 to recover exhaust heat of the charger 9 and deliver the recovered exhaust heat to the transaxle 10. Therefore, the pump 8 of the third circulation circuit 3 is stopped.

In the quick charge mode in summer, while the battery 17 is charged as described above, the temperature of the battery 17 is restrained from rising excessively as a result of the charging thereof, and hence the battery 17 is restrained from deteriorating due to high temperatures. More specifically, the changeover valve 13 is changed over so that the circulation path of the thermal medium in the first circulation circuit 1 becomes the path 1d passing through the battery 17. Furthermore, with the drive of the Peltier element 7 stopped, the operation of opening the shutoff valve 19 is performed to bring the first circulation circuit 1 and the second circulation circuit 2 into communication with each other, and the pump 4 of the first circulation circuit 1 and the pump 5 of the second circulation circuit 2 are driven. In this case, the thermal medium flowing through the battery 17 flows from the first circulation circuit 1 to the second circulation circuit 2, is cooled through heat exchange with outside air in the external heat exchange unit 6 of the circuit 2, then returns to the first circulation circuit 1, and flows through the aforementioned battery 17 again. As a result, the battery 17 is cooled by the aforementioned thermal medium, and the temperature of the battery 17 is restrained from rising excessively, so that the battery 17 is restrained from deteriorating due to high temperatures. It should be noted that there is no need to drive the Peltier element 7 in thus restraining the temperature of the battery 17 from rising excessively. Thus, the amount of the energy consumed to drive the aforementioned Peltier element 7 can be made equal to zero.

FIG. 5 shows a circulation mode of the thermal medium in the first circulation circuit 1, the second circulation circuit 2, and the third circulation circuit 3 at the time when the stopped vehicle is connected to the public power supply in winter. When the vehicle is thus connected to the public power supply as well, the quick charge mode is selected as the charge mode for charging the battery 17. In the quick charge mode in winter, while the battery 17 is charged in the same manner as in the aforementioned quick charge mode in summer, the temperature of the battery 17 is raised to a temperature allowing the battery 17 to be charged. More specifically, the changeover valve 13 is changed over so that the circulation path of the thermal medium in the first circulation circuit 1 becomes the path 1d passing through the battery 17, and the operation of closing the shutoff valve 19 is performed to shut off the first circulation circuit 1 and the second circulation circuit 2 from each other. Furthermore, the pump 4 of the first circulation circuit 1 and the pump 5 of the second circulation circuit 2 are driven, and the Peltier element 7 is driven so that heat transfers from the thermal medium in the second circulation circuit 2 to the thermal medium in the first circulation circuit 1. It should be noted that an outline arrow in the Peltier element 7 in the drawing indicates the transfer of heat resulting from the driving of the Peltier element 7. In this case, the thermal medium flowing through the battery 17 is warmed through the driving of the aforementioned Peltier element 7, then returns to the aforementioned battery 17, and flows through the battery 17 again. As a result, the battery 17 is warmed by the aforementioned thermal medium, and the temperature of the battery 17 swiftly rises to a temperature allowing the battery 17 to be charged. Thus, the time for charging the battery 17 can be reduced, and hence the battery 17 can be restrained from deteriorating due to long hours of charge.

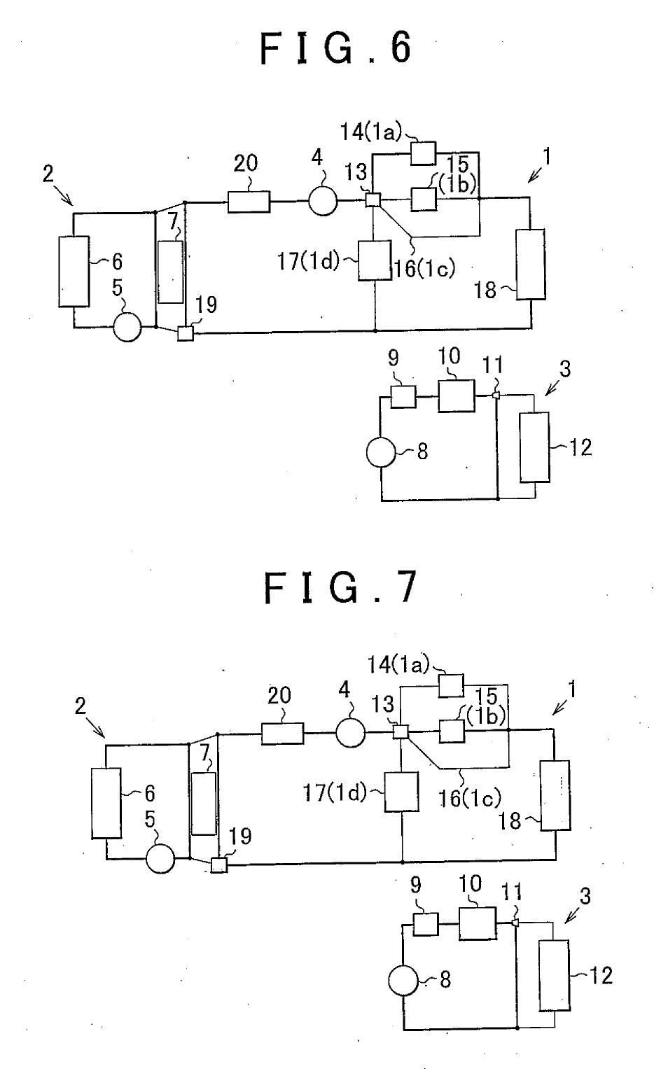

FIG. 6 shows a circulation mode of the thermal medium in the first circulation circuit 1, the second circulation circuit 2, and the third circulation circuit 3 at the time when the vehicle interior is cooled using the cooling heat stored in the cooling heat thermal storage unit 14 during the driving of the vehicle in summer. In this air-conditioning of the vehicle interior through the use of the thermal storage unit (hereinafter referred to as the thermal storage unit air-conditioning), more specifically, in the cooling of the vehicle interior through the use of the cooling heat stored in the cooling heat thermal storage unit 14, the changeover valve 13 is changed over so that the circulation path of the thermal medium in the first circulation circuit 1 becomes the cooling heat thermal storage unit 14 (the path 1a). Furthermore, the operation of closing the shutoff valve 19 is performed to shut off the first circulation circuit 1 and the second circulation circuit 2 from each other, and the pump 4 of the first circulation circuit 1 and the pump 5 of the second circulation circuit 2 are driven. Thus, the thermal medium circulating in the first circulation circuit 1 flows through the cooling heat thermal storage unit 14, and the cooling heat stored in the cooling heat thermal storage unit 14 is conveyed to the internal heat exchange unit 18 through the aforementioned thermal medium. Then, due to heat exchange between the thermal medium in the internal heat exchange unit 18 and air to be sent into the vehicle interior, the air is cooled. The air thus cooled is sent into the vehicle interior, so that the vehicle interior is cooled using the cooling heat stored in the cooling heat thermal storage unit 14. It should be noted that the thermal medium is circulated in the third circulation circuit 3, driven by the pump 8 in this case.

FIG. 7 shows a circulation mode, of the thermal medium in the first circulation circuit 1, the second circulation circuit 2, and the third circulation circuit 3 at the time when the vehicle interior is heated using the warming heat stored in the warming heat thermal storage unit 15 during the driving of the vehicle in winter. In this air-conditioning of the vehicle interior through the use of the thermal storage unit (hereinafter referred to as the thermal storage unit air-conditioning), more specifically, in the heating of the vehicle interior through the use of the warming heat stored in the warming heat thermal storage unit 15, the changeover valve 13 is changed over so that the circulation path of the thermal medium in the first circulation circuit 1 becomes the warming heat thermal storage unit 15 (the path 1b). Furthermore, the operation of closing the shutoff valve 19 is performed to shut off the first circulation circuit 1 and the second circulation circuit 2 from each other, and the pump 4 of the first circulation circuit 1 and the pump 5 of the second circulation circuit 2 are driven. Thus, the thermal medium circulating in the first circulation circuit 1 flows through the warming heat thermal storage unit 15, and the warming heat stored in the warming heat thermal storage unit 15 is conveyed to the internal heat exchange unit 18 through the aforementioned thermal medium. Then, due to heat exchange between the thermal medium in the internal heat exchange unit 18 and air to be sent into the vehicle interior, the air is warmed. The air thus warmed is sent into the vehicle interior, so that the vehicle interior is heated using the warming heat stored in the warming heat thermal storage unit 15. It should be noted that the thermal medium is circulated in the third circulation circuit 3, driven by the pump 8 in ibis case.

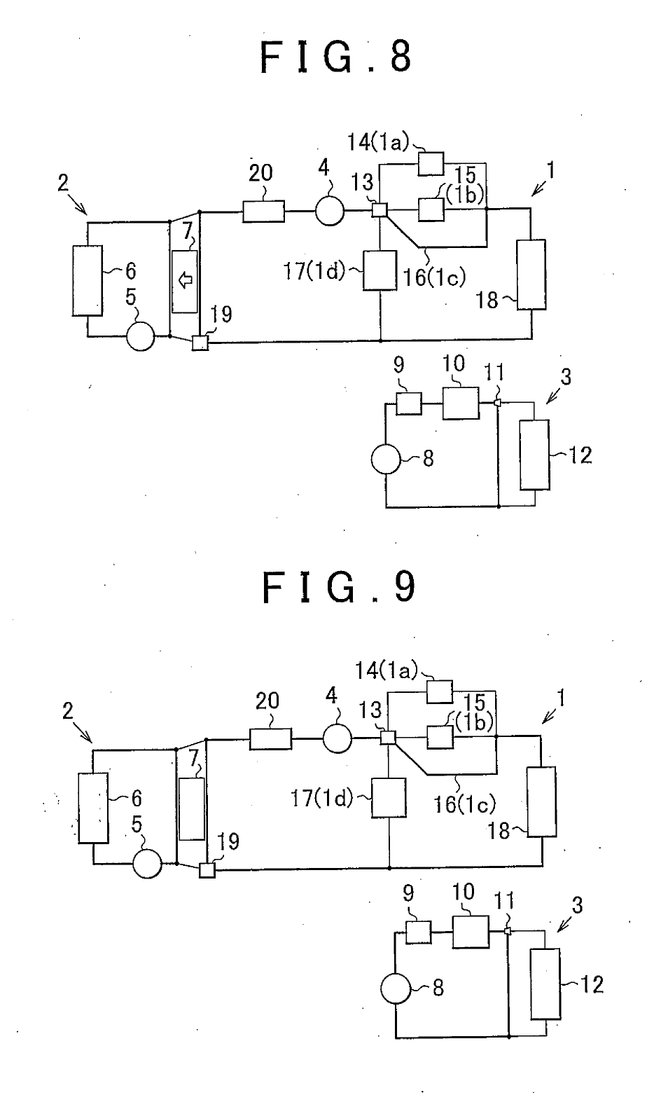

FIG. 8 shows a circulation mode of the thermal medium in the first circulation circuit 1, the second circulation circuit 2, and the third circulation circuit 3 at the time when the vehicle interior is cooled using the Peltier element 7 during the driving of the vehicle in summer. In this air-conditioning of the vehicle interior through the use of the Peltier element 7 (hereinafter referred to as the Peltier air-conditioning), more specifically, in the cooling of the vehicle interior through the use of the Peltier element 7, the changeover valve 13 is changed over so that the circulation path of the thermal medium in the first circulation circuit 1 becomes the bypass passage 16 (the path 1c). Furthermore, the operation of closing the shutoff valve 19 is performed to shut off the first circulation circuit 1 and the second circulation circuit 2 from each other, and the pump 4 of the first circulation circuit 1 and the pump 5 of the second circulation circuit 2 are driven. In this state, the Peltier element 7 is driven so that heat transfers from the thermal medium in the first circulation circuit 1 to the thermal medium in the second circulation circuit 2. It should be noted that an outline arrow in the Peltier element 7 in the drawing indicates the transfer of heat resulting from the driving of the Peltier element 7. In this case, the thermal medium circulating in the first circulation circuit 1 is cooled in the vicinity of the Peltier element 7, and then flows through the internal heat exchange unit 18. Then, due to heat exchange between the thermal medium in the internal heat exchange unit 18 and air delivered to the vehicle interior, the air is cooled. The air thus cooled is sent into the vehicle interior, so that the vehicle interior is cooled using the Peltier element 7. It should be noted that the thermal medium is circulated in the third circulation circuit 3, driven by the pump 8 in this case.

FIG. 9 shows a circulation mode of the thermal medium in the first circulation circuit 1, the second circulation circuit 2, and the third circulation circuit 3 at the time when the vehicle interior is heated using the Peltier element 7 during the driving of the vehicle in winter. In this air-conditioning of the vehicle interior through the use of the Peltier element 7 (hereinafter referred to as the Peltier air-conditioning), more specifically, in the heating of the vehicle interior through the use of the Peltier element 7, the changeover valve 13 is changed over so that the circulation path of the thermal medium in the first circulation circuit 1 becomes the bypass passage 16 (the path 1c). Furthermore, the operation of closing the shutoff valve 19 is performed to shut off the first circulation circuit 1 and the second circulation circuit 2 from each other, and the pump 4 of the first circulation circuit 1 and the pump 5 of the second circulation circuit 2 are driven. In this state, the Peltier element 7 is driven so that heat transfers from the thermal medium in the second circulation circuit 2 to the thermal medium in the first circulation circuit 1. It should be noted that an outline arrow in the Peltier element 7 in the drawing indicates the transfer of heat resulting from the driving of the Peltier element 7. In this case, the thermal medium circulating in the first circulation circuit 1 is warmed in the vicinity of the Peltier element 7, and then flows through the internal heat exchange unit 18. Then, due to heat exchange between the thermal medium in the internal heat exchange unit 18 and air to be sent into the vehicle interior, the air is heated. The air thus warmed is sent into the vehicle interior, so that the vehicle interior is heated using the Peltier element 7. It should be noted that the thermal medium is circulated in the third circulation circuit 3, driven by the pump 8 in this case.

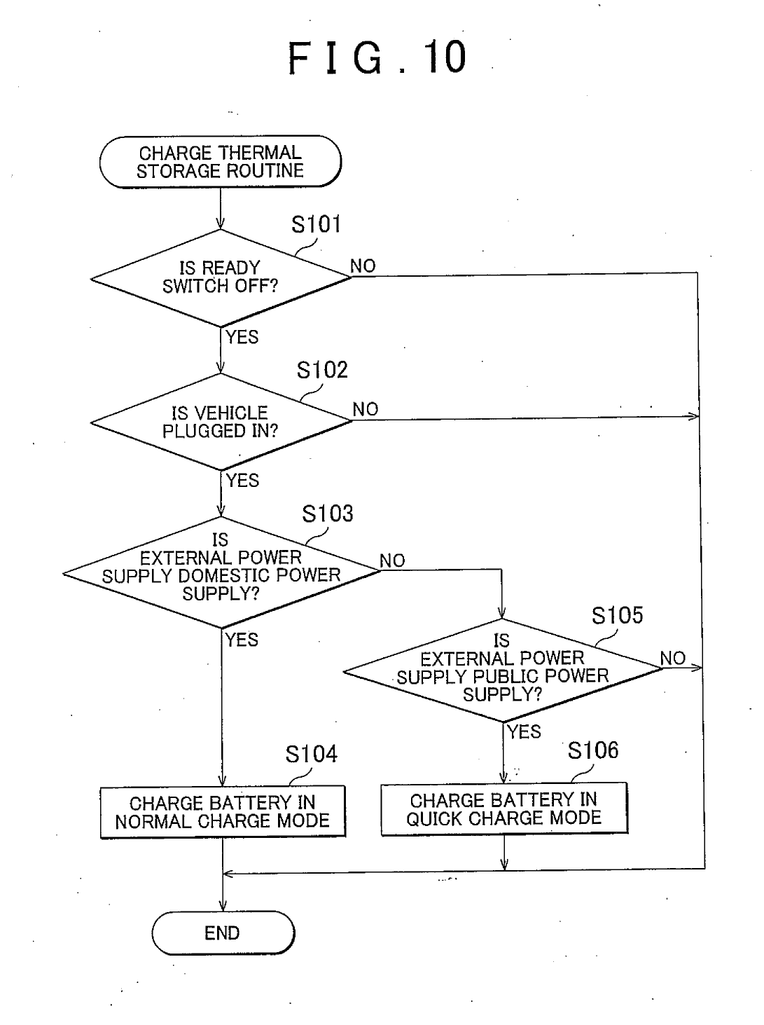

Next, a processing for charging the battery 17 of the vehicle and storing heat into the thermal storage units 14 and 15 during the stoppage of the vehicle will be described with reference to a flowchart of FIG. 10, which shows a charge thermal storage routine. This charge thermal storage routine is periodically executed at intervals of a predetermined interrupt time through the electronic control unit 21.

In this routine, it is determined whether or not the ready switch 25 is operated to an off position, namely, a driving stop position (S101) and whether or not the vehicle is connected (plugged in) to the external power supply (S102). When an affirmative determination is then made in both the processing of S101 and the processing of S102, it is determined that the vehicle is stopped and is connected to the external power supply. In this case, processings for charging the battery 17 (S103 to S106) are performed.

In this series of the processings, when it is determined that the external power supply connected to the vehicle is a domestic power supply (S103: YES), the battery 17 is charged in the normal charge mode (S104). When the battery 17 is thus charged in the normal charge mode, cooling heat is stored into the cooling heat thermal storage unit 14, or warming heat is stored into the warming heat thermal storage unit 15. To be more specific, cooling heat is stored into the cooling heat thermal storage unit 14 as shown in FIG. 2 in summer. Further, warming heat is stored into the warming heat thermal storage unit 15 as shown in FIG. 3 in winter.

Further, in the aforementioned series of the processings (S103 to S106 of FIG. 10), when it is determined that the external power supply connected to the vehicle is a public power supply (S105: YES), the battery 17 is charged in the quick charge mode (S106). When the battery 17 is thus charged in the quick charge mode, the temperature of the battery 17 is restrained from rising excessively, or the temperature of the battery 17 is raised to a value allowing the battery 17 to be charged. To be more specific, in summer, the thermal medium is circulated as indicated by a thick line in FIG. 4 to cool the thermal medium, and the temperature of the battery 17 is restrained from rising excessively using the thermal medium. Further, in winter, the thermal medium is circulated as indicated by thick lines in FIG. 5, the thermal medium in the first circulation circuit 1 is warmed through the driving of the Peltier element 7, and the temperature of the battery 17 is raised using the thermal medium.

Next, a processing performed in carrying out the air-conditioning of the vehicle interior during the driving of the vehicle will be described with reference to a flowchart of FIG. 11, which shows an air-conditioning routine. This control routine is periodically executed at intervals of a predetermined interrupt time through the electronic control unit 21.

In this routine, it is determined whether or not the vehicle is disconnected (plugged off) from the external power supply (S201) and whether or not the ready switch 25 is operated to an on position, namely, a driving start position (S202). When an affirmative determination is then made in both the processing of S201 and the processing of S202, it is determined that the vehicle is not connected to the external power supply and that the vehicle is driven. In this case, processings for carrying out the air-conditioning of the vehicle interior (S203 to S205) are performed.

In this series of the processings, it is first determined whether or not an air-conditioning request, namely, a cooling request or a heating request can be met by stored heat (S203). This determination is made based on the magnitude of the aforementioned air-conditioning request and the amount of the heat (cooling heat or warming heat) that can be taken out from the thermal storage units 14 and 15 per unit time. It should be noted herein that the magnitude of the aforementioned air-conditioning request is calculated based on a difference between an actual temperature (a blowoff temperature) of the air to be sent into the vehicle interior through the internal heat exchange unit 18 and a target value thereof (a target blowout temperature). Further, the amount of the heat that can be taken out from the thermal storage units 14 and 15 per unit time is calculated based on the temperature in the thermal storage units 14 and 15 and the flow rate of the thermal medium flowing through the thermal storage units 14 and 15 per unit time. It should be noted that the flow rate of the thermal medium flowing through the thermal storage units 14 and 15 per unit time can be calculated based on a drive command value (a drive rate) of the pump 4 in the first circulation circuit 1. For reference, as the amount of the heat that can be taken out from the thermal storage units 14 and 15 per unit time, the amount of the heat (cooling heat) that can be taken out from the cooling heat thermal storage unit 14 per unit time is calculated when a request for cooling is made, and the amount of the heat (warming heat) that can be taken out from the warming heat thermal storage unit 15 per unit time is calculated when a request for heating is made.

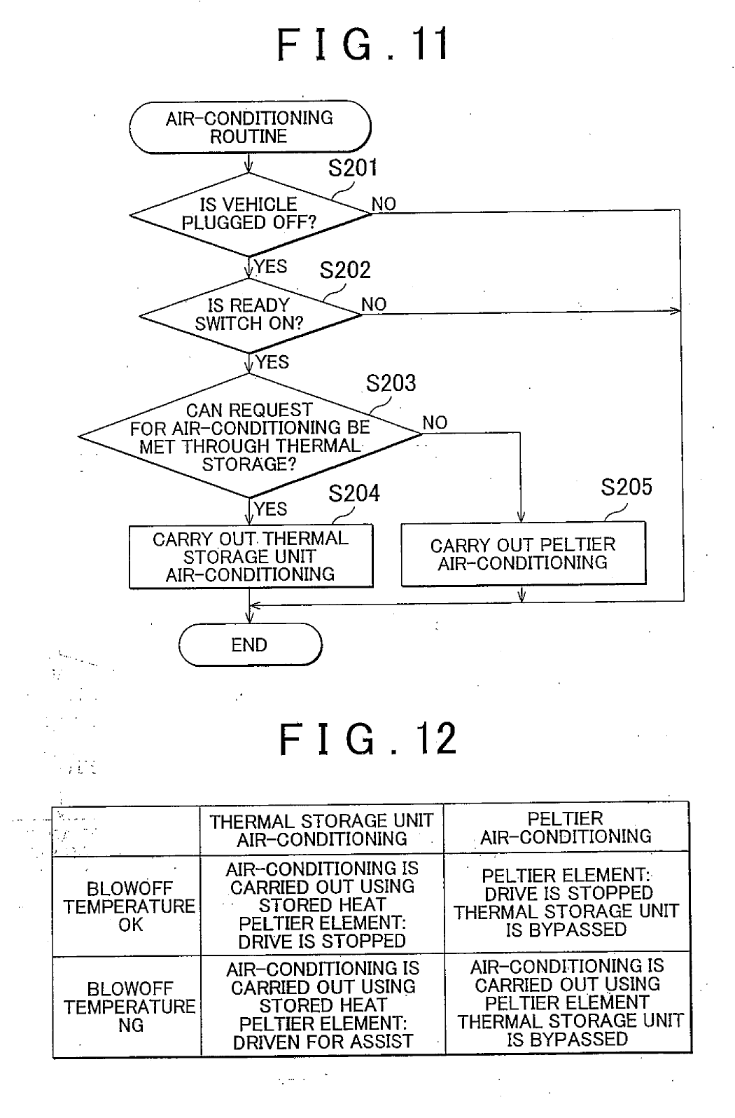

In the aforementioned 5203, when a request for cooling is made, it is determined, based on the difference between the aforementioned blowoff temperature and the aforementioned target blowoff temperature, and the amount of the heat (cooling heat) that can be taken out from the cooling heat thermal storage unit 14 per unit time, whether or not the air-conditioning request can be met by stored heat. Further, when a request for heating is made, it is determined, based on the difference between the aforementioned blowoff temperature and the aforementioned target blowoff temperature, and the amount of the heat (warming heat) that can be taken out from the warming heat thermal storage unit 15 per unit time, whether or not the air-conditioning request can be met by stored heat. Then, when it is determined in the aforementioned S203 that the air-conditioning request can be met by stored heat, the thermal storage unit air-conditioning (S204) is carried out. When it is determined that the air-conditioning request cannot be met by stored heat, the Peltier air-conditioning is carried out (S205). A chart of FIG. 12 shows the details of the mode of carrying out this thermal storage unit air-conditioning and the mode of carrying out this Peltier air-conditioning.

As is apparent from this drawing, in the aforementioned thermal storage unit air-conditioning, the air-conditioning is carried out using the thermal storage units 14 and 15. To be more specific, when a request for cooling is made, the changeover valve 13 is changed over so that thermal medium in the first circulation circuit 1 circulates as indicated by thick lines in FIG. 6. Thus, the vehicle interior is cooled using the cooling heat stored in the cooling heat thermal storage unit 14. Further, when a request for heating is made, the changeover valve 13 is changed over so that the thermal medium in the first circulation circuit 1 circulates a indicated by thick lines in FIG. 7. Thus, the vehicle interior is heated using the warming heat stored in the warming heat thermal storage unit 15.

When the aforementioned thermal storage unit air-conditioning is carried out, the drive of the Peltier element 7 is basically stopped, but may be driven in order to assist the aforementioned thermal storage unit air-conditioning. To be more specific, when the difference between the actual temperature (the blowoff temperature) of the air to be sent into the vehicle interior through the internal heat exchange unit 18 and the target value thereof (the target blowoff temperature) is a value within a predetermined permissible range (“BLOWOFF TEMPERATURE OK” in FIG. 12), the drive of the Peltier element 7 is stopped. On the other hand, when the difference between the aforementioned blowoff temperature and the aforementioned target blowoff temperature is a value outside the aforementioned permissible range (“BLOWOFF TEMPERATURE NG” in FIG. 12), the Peltier element 7 is driven in order to assist the aforementioned thermal storage unit air-conditioning. When a request for cooling is made, the Peltier element 7 is thus driven so that heat transfers from the thermal medium in the first circulation circuit 1 to the thermal medium in the second circulation circuit 2. Further, when a request for heating is made, the aforementioned Peltier element 7 is driven so that heat transfers from the thermal medium in the second circulation circuit 2 to the thermal medium in the first circulation circuit 1.

On the other hand, as is apparent from FIG. 12, in the aforementioned Peltier air-conditioning, the air-conditioning of the vehicle interior is carried out using the Peltier element 7. In this Peltier air-conditioning, the changeover valve 13 is changed over so that the thermal medium in the first circulation circuit 1 circulates as indicated by thick lines in FIGS. 8 and 9. Then, when the difference between the aforementioned blowoff temperature and the aforementioned target blowoff temperature is a value within the aforementioned permissible range (“BLOWOFF TEMPERATURE OK” in FIG. 12), the drive of the Peltier element 7 is stopped. On the other hand, when the difference between the aforementioned blowoff temperature and the aforementioned target blowoff temperature is a value outside the aforementioned permissible range (“BLOWOFF TEMPERATURE NG” in FIG. 12), the Peltier element 7 is driven to carry out the air-conditioning of the vehicle interior. When a request for cooling is made, the Peltier element 7 is thus driven so that heat transfers from the thermal medium in the first circulation circuit 1 to the thermal medium in the second circulation circuit 2. By driving the Peltier element 7 in this way, the vehicle interior is cooled using the Peltier element 7. Further, when a request for heating is made, the aforementioned Peltier element 7 is driven so that heat transfers from the thermal medium in the second circulation circuit 2 to the thermal medium in the first circulation circuit 1. By driving the Peltier element 7 in this way, the vehicle interior is heated using the Peltier element 7.

According to this embodiment of the invention described above in detail, effects shown below are obtained.

(1) The Peltier element 7 is used as a heat transfer device for carrying out the air-conditioning of the vehicle interior through the transfer of heat between the thermal medium in the first circulation circuit 1 and the thermal medium in the second circulation circuit 2. Therefore, the structure of the circuits and the like in the thermal control apparatus for the vehicle does not become complicated as in a case where a vapor compression-type heat pump or the like is used as the device.

(2) When a request to cool the vehicle interior is made and can be met by the cooling heat stored in the cooling heat thermal storage unit. 14, the vehicle interior is cooled using the cooling heat stored in the cooling heat thermal storage unit 14 with the drive of the Peltier element 7 stopped as shown in FIG. 6. On the other hand, when a request to heat the vehicle interior is made and can be met by the warming heat stored in the warming heat thermal storage unit 15, the vehicle interior is heated using the warming heat stored in the warming heat thermal storage unit 15 with the drive of the Peltier element 7 stopped as shown in FIG. 7. By carrying out the thermal storage unit air-conditioning using the cooling heat in the cooling heat thermal storage unit 14 or the warming heat in the warming heat thermal storage unit 15 for the air-conditioning of the vehicle interior in this way, the number of times the Peltier element 7 is driven and the power supplied thereto in carrying out the air-conditioning of the vehicle interior can be minimized. Accordingly, the amount of the energy consumed in driving the Peltier element 7 in carrying out the air-conditioning of the vehicle interior can be minimized.

(3) When a request to cool the vehicle interior is made and cannot be met by the cooling heat stored in the cooling heat thermal storage unit 14 because the amount thereof is small, the Peltier element 7 is driven so that heat transfers from the thermal medium in the first circulation circuit 1 to the thermal medium in the second circulation circuit 2 as shown in FIG. 8. By carrying out the Peltier air-conditioning through the use of this Peltier element 7, the request to cool the vehicle interior can be met even when the amount of the cooling heat stored in the cooling heat thermal storage unit 14 is small. Further, when a request to heat the vehicle interior is made and cannot be met by the warming heat stored in the warming heat thermal storage unit 15 because the amount thereof is small, the Peltier element 7 is driven so that heat transfers from the thermal medium in the second circulation circuit 2 to the thermal medium in the first circulation circuit 1 as shown in FIG. 9. By carrying out the Peltier air-conditioning through the use of this Peltier element 7, the request to heat the vehicle interior can be met even when the amount of the warming heat stored in the warming heat thermal storage unit 15 is small.

(4) When the vehicle is disconnected from the external power supply during the running or the like of the vehicle, the Peltier element 7 is driven using the battery 17. On the other hand, when the vehicle is connected to the external power supply, the Peltier element 7 is driven using the external power supply. When the vehicle is connected to the external power supply, warming heat is stored into the warming heat thermal storage unit 15 as shown in FIG. 3, or cooling heat is stored into the cooling heat thermal storage unit 14 as shown in FIG. 2, through the driving of the changeover valve 13 and the Peltier element 7. During this, the Peltier element 7 is driven using the external power supply instead of the battery 17. Therefore, warming heat can be stored into the warming heat thermal storage unit 15 or cooling heat can be stored into the cooling heat thermal storage unit 14, without consuming the power stored in the battery 17 in driving the aforementioned Peltier element 7.

(5) When the vehicle is connected to the external power supply to charge the battery 17 and the quick charge mode is selected as the charge mode, the circulation path of the thermal medium in the first circulation circuit 1 is the path 1d passing through the battery 17. In summer, in order to restrain the temperature of the battery 17 from rising excessively during the charging of the battery 17 in the quick charge mode, the shutoff valve 19 is opened to bring the first circulation circuit 1 into communication with the second circulation circuit 2 with the drive of the Peltier element 7 stopped. In this case, as shown in FIG. 4, the thermal medium flowing through the battery 17 flows from the first circulation circuit 1 to the second circulation circuit 2, is cooled through heat exchange with outside air in the external heat exchange unit 6 of the circuit 2, then returns to the first circulation circuit 1, and flows through the aforementioned battery 17 again. As a result, the battery 17 is cooled by the aforementioned thermal medium, and the temperature of the battery 17 is restrained from rising excessively, so that the battery 17 is restrained from deteriorating due to high temperatures. Further, since there is no need to drive the Peltier element 7 in restraining the temperature of the aforementioned battery 17 from rising excessively, the amount of the energy consumed to drive the Peltier element 7 can be made equal to zero. On the other hand, in winter, in order to raise the temperature of the battery 17 to a temperature allowing the battery 17 to be charged during the charging of the battery 17 in the quick charge mode, the shutoff valve 19 is closed to shut off the first circulation circuit 1 from the second circulation circuit 2, and the Peltier element 7 is driven so that heat transfers from the thermal medium in the second circulation circuit 2 to the thermal medium in the first circulation circuit 1. In this case, as shown in FIG. 5, the thermal medium flowing through the battery 17 is warmed through the driving of the aforementioned Peltier element 7, then returns to the aforementioned battery 17, and flows through the battery 17 again. As a result, the battery 17 is warmed by the aforementioned thermal medium, and the temperature of the battery 17 swiftly rises to a temperature allowing the battery 17 to be charged. The time for charging the battery 17 can thereby be reduced, and hence the battery 17 can be restrained from deteriorating due to long hours of charge.

(6) Since the inverter 20 as the exhaust heat recovery object is provided in the first circulation circuit 1, the exhaust heat of the inverter 20 can be efficiently used to heat the vehicle in winter. It should be noted that the foregoing embodiment of the invention can also be changed, for example, as follows.

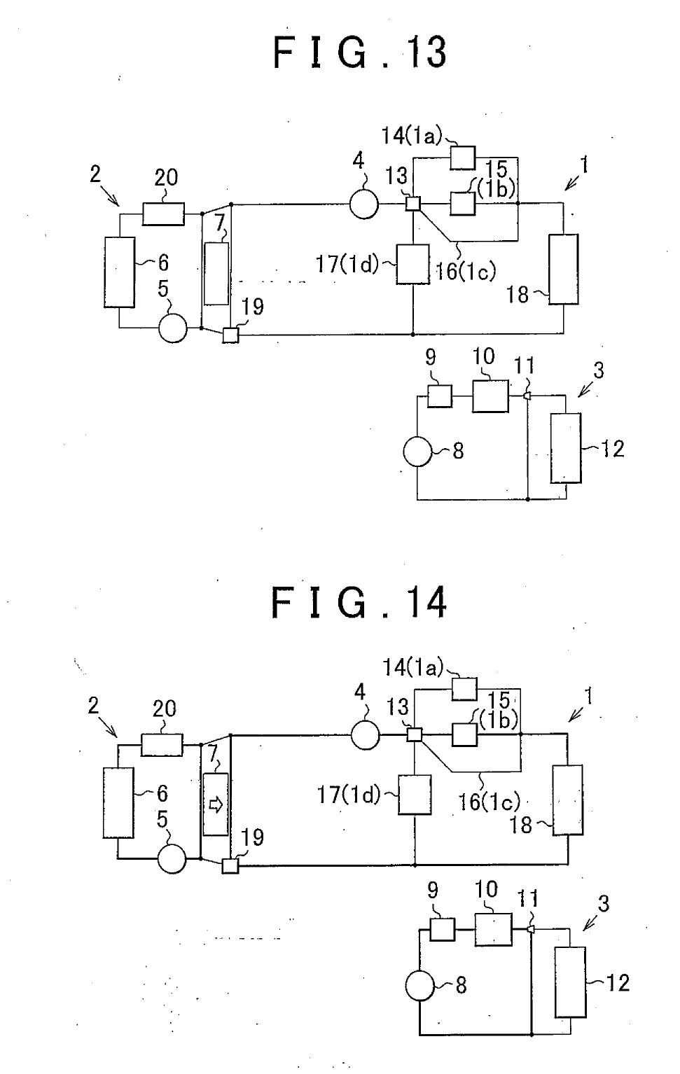

The inverter 20 as the exhaust heat recovery object may be provided in the second circulation circuit 2 as shown in FIG. 13. In this case, since the exhaust heat from the inverter 20 is recovered by the thermal medium circulating in the second circulation circuit 2, the external heat exchange unit 6 and the like in the second circulation circuit 2 are unlikely to freeze in winter due to the recovered exhaust heat. Further, during the thermal storage unit air-conditioning in winter in this case, in order to assist the heating of the vehicle interior through the use of the warming heat in the warming heat thermal storage unit 15, it is preferable to drive the Peltier element 7 so that heat transfers from the thermal medium in the second circulation circuit 2 in which the exhaust heat of the inverter 20 is recovered to the thermal medium in the first circulation circuit 1 as shown in FIG. 14.

Although the inverter 20 is illustrated as the exhaust heat recovery object, the exhaust heat recovery object may be an object other than the inverter 20, such as an LED for a headlamp, a box body for a navigation system, or the like.

In carrying out the Peltier air-conditioning, the changeover valve 13 may be changed over so that the circulation path of the thermal medium in the first circulation circuit 1 becomes the cooling heat thermal storage unit 14 (the path 1a) during cooling and becomes the warming heat thermal storage unit 15 (the path 1b) during heating. In this case, although a request for the air-conditioning of the vehicle interior cannot be met by the cooling heat in the cooling heat thermal storage unit 14 or the warming heat in the warming heat thermal storage unit 15, the Peltier air-conditioning can be assisted through the use of the cooling heat or the warming heat. Further, as in the foregoing embodiment of the invention, when the changeover valve 13 is changed over so that the circulation path of the thermal medium in the first circulation circuit 1 becomes the bypass passage 16 (the path 1d) during the Peltier air-conditioning, the thermal medium circulating in the first circulation circuit 1 can be prevented from flowing through the warming heat thermal storage unit 15 or the cooling heat thermal storage unit 14. Thus, the warming heat stored in the warming heat thermal storage unit 15 and the cooling heat stored in the cooling heat thermal storage unit 14 can be restrained from being discharged from the thermal storage units 15 and 14 by the thermal medium flowing through the thermal storage units 15 and 14, respectively.

The drive of the Peltier element 7 may always be stopped during the thermal storage unit air-conditioning. A configuration may be employed, in which one of the cooling heat thermal storage unit 14 and the warming heat thermal storage unit 15 is provided to carry out one of cooling heat thermal storage and warming heat thermal storage.

A thermal storage unit having the functions of both the cooling heat thermal storage unit 14 and the warming heat thermal storage unit 15 may be provided to carry out cooling heat thermal storage and warming heat thermal storage. In this case, it is preferable to carry out cooling heat thermal storage in summer by the aforementioned thermal storage unit, and to carry out warming heat thermal storage in winter by the aforementioned thermal storage unit.

Instead of providing a branching region of the paths 1a to 1d with the changeover valve 13, it is also appropriate to provide each of the paths 1a to 1d with a changeover valve that brings the path into and out of communication. Instead of providing the aforementioned changeover valve 13, it is also appropriate to provide a meeting region of the paths 1a to 1c with a changeover valve that makes a changeover to one of the paths 1a to 1c, and to provide the path 1d with a changeover valve that brings the path 1d into and out of communication.

The invention has been described with reference to the example embodiment thereof for illustrative purposes only. It should be understood that the description is not intended to be exhaustive or to limit the form of the invention and that the invention may be adapted for use in other systems and applications. The scope of the invention embraces various modifications and equivalent arrangements that may be conceived by one skilled in the art.

1.-18. (canceled)

19. A thermal control apparatus for a vehicle, comprising:
a first circulation circuit that causes a thermal medium to circulate and flow through an internal heat exchange unit to perform, in the internal heat exchange unit, heat exchange between the thermal medium and air to be sent into a vehicle interior;
a second circulation circuit that causes a thermal medium to circulate and flow through an external heat exchange unit to perform, in the external heat exchange unit, heat exchange between the thermal medium and outside air;
a heat transfer device that transfers heat between the thermal medium in the first circulation circuit and the thermal medium in the second circulation circuit; and
a control section that performs drive control of the heat transfer device,
wherein:
the heat transfer device is a Peltier element;
the first circulation circuit is equipped with a thermal storage unit that stores therein cooling heat or warming heat of the thermal medium, a bypass passage that bypasses the thermal storage unit, and a changeover valve that changes over a circulation path of the thermal medium in the first circulation circuit to one of the thermal storage unit and the bypass passage;
the control section is configured to perform changeover control of the changeover valve and the drive control of the heat transfer device;
the vehicle includes a battery and is configured to be connectable to an external power supply to charge the battery during stoppage of the vehicle;
the control section is configured to store cooling heat or warming heat into the thermal storage unit through driving of the changeover valve and the Peltier element when the vehicle is connected to the external power supply;
the vehicle is configured so that one of charge modes, which are a normal charge mode and a quick charge mode, is selected when the vehicle is connected to the external power supply to charge the battery;
the first circulation circuit includes, in addition to the thermal storage unit and the bypass passage, a path passing through the battery as a circulation path of the thermal medium and is configured to be brought into communication with or shut off from the second circulation circuit through operation of a shutoff valve;
the changeover valve is configured to change over the circulation path of the thermal medium in the first circulation circuit to one of the thermal storage unit, the bypass passage, and the path passing through the battery; and
the control section is configured to drive the changeover valve and the Peltier element to store cooling heat or warming heat into the thermal storage unit in the normal charge mode, and is configured to change over the changeover valve so that the circulation path of the thermal medium in the first circulation circuit becomes the path passing through the battery, and open the shutoff valve to bring the first circulation circuit into communication with the second circulation circuit with the drive of the Peltier element stopped to restrain a temperature of the battery from rising excessively, or close the shutoff valve to shut off the first circulation circuit from the second circulation circuit and drive the Peltier element so that heat transfers from the thermal medium in the second circulation circuit to the thermal medium in the first circulation circuit to raise the temperature of the battery to a temperature allowing the battery to be charged, in the quick charge mode.

21. The thermal control apparatus according to claim 19, wherein
the control section is configured to perform the drive control of the heat transfer device and the changeover control of the changeover valve based on whether or not an air-conditioning request to carry out air-conditioning of a vehicle interior can be met by the cooling heat or the warming heat stored in the thermal storage unit when the air-conditioning request is made.

22. The thermal control apparatus according to claim 19, wherein
the control section is configured to change over the changeover valve so that the circulation path of the thermal medium in the first circulation circuit becomes the thermal storage unit and stop driving the Peltier element when it is determined that an air-conditioning request to carry out air-conditioning of the vehicle interior is made and can be met by the cooling heat or the warming heat stored in the thermal storage unit, and is configured to drive the Peltier element so that heat transfers from the thermal medium in the second circulation circuit to the thermal medium in the first circulation circuit when it is determined that the air-conditioning request is made and cannot be met by the cooling heat or the warming heat stored in the thermal storage unit.

23. The thermal control apparatus according to claim 19, wherein:
the first circulation circuit is equipped, as the thermal storage unit, with a cooling heat thermal storage unit that stores therein cooling heat of the thermal medium and a warming heat thermal storage unit that stores therein warming heat of the thermal medium;
the bypass passage bypasses the cooling heat thermal storage unit and the warming heat thermal storage unit; and
the changeover valve is configured to change over the circulation path of the thermal medium in the first circulation circuit to one of the cooling heat thermal storage unit, the warming heat thermal storage unit, and the bypass passage.

24. The thermal control apparatus according to claim 22, wherein
the control section is configured to change over the changeover valve so that the circulation path of the thermal medium in the first circulation circuit becomes the warming heat thermal storage unit and stop driving the Peltier element when it is determined that a heating request to heat the vehicle interior is made and can be met by the warming heat stored in the warming heat thermal storage unit, and is configured to drive the Peltier element so that heat transfers from the thermal medium in the second circulation circuit to the thermal medium in the first circulation circuit when it is determined that the heating request is made and cannot be met by the warming heat stored in the warming heat thermal storage unit.

25. The thermal control apparatus according to claim 22, wherein
the control section is configured to change over the changeover valve so that the circulation path of the thermal medium in the first circulation circuit becomes the cooling heat thermal storage unit and stop driving the Peltier element when it is determined that a cooling request to cool the vehicle interior is made and can be met by the cooling heat stored in the cooling heat thermal storage unit, and is configured to drive the Peltier element so that heat transfers from the thermal medium in the first circulation circuit to the thermal medium in the second circulation circuit when it is determined that the cooling request is made and cannot be met by the cooling heat stored in the cooling heat thermal storage unit.

26. The thermal control apparatus according to claim 22, wherein
the vehicle includes a battery and is configured to be connectable to an external power supply to charge the battery during stoppage of the vehicle, and
the control section is configured to store warming heat into the warming heat thermal storage unit or store cooling heat into the cooling heat thermal storage unit through driving of the changeover valve and the Peltier element when the vehicle is connected to the external power supply.

27. The thermal control apparatus according to claim 26, wherein:
the vehicle is configured so that one of charge modes, which are a normal charge mode and a quick charge mode, is selected when the vehicle is connected to the external power supply to charge the battery;
the first circulation circuit includes, in addition to the cooling heat thermal storage unit, the warming heat thermal storage unit, and the bypass passage, a path passing through the battery, as a circulation path of the thermal medium and is configured to be brought into communication with or shut off from the second circulation circuit through operation of a shutoff valve;
the changeover valve is configured to change over the circulation path of the thermal medium in the first circulation circuit to one of the cooling heat thermal storage unit, the warming heat thermal storage unit, the bypass passage, and the path passing through the battery; and
the control section is configured to drive the changeover valve and the Peltier element to store warming heat into the warming heat thermal storage unit or store cooling heat into the cooling heat thermal storage unit in the normal charge mode, and is configured to change over the changeover valve so that the circulation path of the thermal medium in the first circulation circuit becomes the path passing through the battery, and open the shutoff valve to bring the first circulation circuit into communication with the second circulation circuit with the drive of the Peltier element stopped to restrain a temperature of the battery from rising excessively, or close the shutoff valve to shut off the first circulation circuit from the second circulation circuit and drive the Peltier element so that heat transfers from the thermal medium in the second circulation circuit to the thermal medium in the first circulation circuit to raise the temperature of the battery to a temperature allowing the battery to be charged, in the quick charge mode.

28. A thermal control method for a vehicle, comprising:
performing heat exchange in a first circulation circuit that causes a thermal medium to flow through an internal heat exchange unit to perform the heat exchange between the thermal medium and air to be sent into a vehicle interior, wherein the first circulation circuit is equipped with a thermal storage unit that stores therein cooling heat or warming heat of the thermal medium, a bypass passage that bypasses the thermal storage unit, and a changeover valve that changes over a circulation path of the thermal medium to one of the thermal storage unit and the bypass passage;
performing heat exchange in a second circulation circuit that causes a thermal medium to flow through an external heat exchange unit to perform the heat exchange between the thermal medium and outside air;
transferring heat between the thermal medium in the first circulation circuit and the thermal medium in the second circulation circuit via a Peltier element; and
performing drive control of the Peltier element and changeover control of the changeover valve based on whether or not an air-conditioning request to carry out air-conditioning of the vehicle interior can be met by the cooling heat or the warming heat stored in the thermal storage unit; wherein
the vehicle includes a battery and is configured to be connectable to an external power supply to charge the battery during stoppage of the vehicle, and
the thermal control method further comprises storing cooling heat or warming heat into the thermal storage unit through driving of the changeover valve and the Peltier element when the vehicle is connected to the external power supply; and wherein:
the first circulation circuit includes, in addition to the thermal storage unit and the bypass passage, a path passing through the battery as a circulation path of the thermal medium and is configured to be brought into communication with or shut off from the second circulation circuit through operation of a shutoff valve;
the changeover valve is configured to change over the circulation path of the thermal medium in the first circulation circuit to one of the thermal storage unit, the bypass passage, and the path passing through the battery; and
the thermal control method further comprises:
selecting one of charge modes, which are a normal charge mode and a quick charge mode, when the vehicle is connected to the external power supply to charge the battery;
performing the changeover control of the changeover valve and the drive control of the Peltier element to store cooling heat or warming heat into the thermal storage unit in the normal charge mode; and
changing over the changeover valve so that the circulation path of the thermal medium in the first circulation circuit becomes the path passing through the battery, and, to restrain a temperature of the battery from rising excessively, opening the shutoff valve to bring the first circulation circuit into communication with the second circulation circuit with the drive of the Peltier element stopped, or, to raise the temperature of the battery to a temperature allowing the battery to be charged, closing the shutoff valve to shut off the first circulation circuit from the second circulation circuit and driving the Peltier element so that heat transfers from the thermal medium in the second circulation circuit to the thermal medium in the first circulation circuit, in the quick charge mode.

29. The thermal control method according to claim 28, wherein
the drive control and the changeover control includes:
changing over the changeover valve so that the circulation path of the thermal medium in the first circulation circuit becomes the thermal storage unit and stopping driving the Peltier element when it is determined that the air-conditioning request can be met by the cooling heat or the warming heat stored in the thermal storage unit; and
driving the Peltier element so that heat transfers from the thermal medium in the second circulation circuit to the thermal medium in the first circulation circuit when it is determined that the air-conditioning request cannot be met by the cooling heat or the warming heat stored in the thermal storage unit.

30. The thermal control method according to claim 28, wherein:
the first circulation circuit is equipped, as the thermal storage unit, with a cooling heat thermal storage unit that stores therein cooling heat of the thermal medium and a warming heat thermal storage unit that stores therein warming heat of the thermal medium;
the bypass passage bypasses the cooling heat thermal storage unit and the warming heat thermal storage unit;
the changeover valve is configured to change over the circulation path of the thermal medium in the first circulation circuit to one of the cooling heat thermal storage unit, the warming heat thermal storage unit, and the bypass passage; and
the thermal control method further comprises:
changing over the changeover valve so that the circulation path of the thermal medium in the first circulation circuit becomes the warming heat thermal storage unit and stopping driving the Peltier element when it is determined that a heating request to heat the vehicle interior can be met by the warming heat stored in the warming heat thermal storage unit; and
driving the Peltier element so that heat transfers from the thermal medium in the second circulation circuit to the thermal medium in the first circulation circuit when it is determined that the heating request cannot be met by the warming heat stored in the warming heat thermal storage unit.

31. The thermal control method according to claim 28, wherein:
the first circulation circuit is equipped, as the thermal storage unit, with a cooling heat thermal storage unit that stores therein cooling heat of the thermal medium and a warming heat thermal storage unit that stores therein warming heat of the thermal medium;
the bypass passage bypasses the cooling heat thermal storage unit and the warming heat thermal storage unit;
the changeover valve is configured to change over the circulation path of the thermal medium in the first circulation circuit to one of the cooling heat thermal storage unit, the warming heat thermal storage unit, and the bypass passage; and
the thermal control method further comprises:
changing over the changeover valve so that the circulation path of the thermal medium in the first circulation circuit becomes the cooling heat thermal storage unit and stopping driving the Peltier element when it is determined that a cooling request to cool the vehicle interior can be met by the cooling heat stored in the cooling heat thermal storage unit; and
driving the Peltier element so that heat transfers from the thermal medium in the first circulation circuit to the thermal medium in the second circulation circuit when it is determined that the cooling request cannot be met by the cooling heat stored in the cooling heat thermal storage unit.

32. The thermal control method according to claim 28, wherein:
the first circulation circuit is equipped, as the thermal storage unit, with a cooling heat thermal storage unit that stores therein cooling heat of the thermal medium and a warming heat thermal storage unit that stores therein warming heat of the thermal medium;
the bypass passage bypasses the cooling heat thermal storage unit and the warming heat thermal storage unit;
the changeover valve is configured to change over the circulation path of the thermal medium in the first circulation circuit to one of the cooling heat thermal storage unit, the warming heat thermal storage unit, and the bypass passage;
the vehicle includes a battery and is configured to be connectable to an external power supply to charge the battery during stoppage of the vehicle; and
the thermal control method further comprises:
storing warming heat into the warming heat thermal storage unit or storing cooling heat into the cooling heat thermal storage unit through driving of the changeover valve and the Peltier element when the vehicle is connected to the external power supply.

33. The thermal control method according to claim 32, wherein:
the first circulation circuit includes, in addition to the cooling heat thermal storage unit, the warming heat thermal storage unit, and the bypass passage, a path passing through the battery, as a circulation path of the thermal medium and is configured to be brought into communication with or shut off from the second circulation circuit through operation of a shutoff valve;
the changeover valve is configured to change over the circulation path of the thermal medium in the first circulation circuit to one of the cooling heat thermal storage unit, the warming heat thermal storage unit, the bypass passage, and the path passing through the battery; and
the thermal control method further comprises:
selecting one of charge modes, which are a normal charge mode and a quick charge mode, when the vehicle is connected to the external power supply to charge the battery;
performing the changeover control of the changeover valve and the drive control of the Peltier element to store warming heat into the warming heat thermal storage unit or store cooling heat into the cooling heat thermal storage unit in the normal charge mode; and
changing over the changeover valve so that the circulation path of the thermal medium in the first circulation circuit becomes the path passing through the battery, and, to restrain a temperature of the battery from rising excessively, opening the shutoff valve to bring the first circulation circuit into communication with the second circulation circuit with the drive of the Peltier element stopped, or, to raise the temperature of the battery to a temperature allowing the battery to be charged, closing the shutoff valve to shut off the first circulation circuit from the second circulation circuit and driving the Peltier element so that heat transfers from the thermal medium in the second circulation circuit to the thermal medium in the first circulation circuit, in the quick charge mode.
